(19) United States
(12) Patent Application Publication
(10) Pub. No.: US 2026/0140287 A1
(43) Pub. Date: May 21, 2026

(54) LIQUID CRYSTAL COMPOSITION, OPTICAL ABSORPTION ANISOTROPIC FILM, METHOD OF PRODUCING OPTICAL ABSORPTION ANISOTROPIC FILM, OPTICAL LAMINATE, AND IMAGE DISPLAY APPARATUS

(71) Applicant: FUJIFILM Corporation, Tokyo (JP)

(72) Inventors: Soichiro WATANABE, Minamiashigara-shi (JP); Hiroshi MATSUYAMA, Minamiashigara-shi (JP); Wataru HOSHINO, Minamiashigara-shi (JP)

(73) Assignee: FUJIFILM Corporation, Tokyo (JP)

(21) Appl. No.: 19/447,011

(22) Filed: Jan. 13, 2026

Related U.S. Application Data
(63) Continuation of application No. PCT/JP2024/021859, filed on Jun. 17, 2024.

(30) Foreign Application Priority Data
Jul. 20, 2023 (JP) 2023-118003

(51) Int. Cl. G02B 5/00; C09K 19/60

(52) U.S. Cl. CPC G02B 5/003; C09K 19/601; C09K 2219/03

(57) ABSTRACT

An object of the present invention is to provide a liquid crystal composition having excellent solubility and capable of producing an optical absorption anisotropic film having a high alignment degree, an optical absorption anisotropic film, a method of producing the optical absorption anisotropic film, an optical laminate, and an image display apparatus. The liquid crystal composition according to the present invention is a liquid crystal composition containing a dichroic substance represented by Formula (1) and a liquid crystal compound.

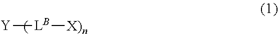

Here, in Formula (1), Y represents an n-valent coloring agent skeleton structure. n represents an integer of one or more. L^{B} represents a divalent aliphatic hydrocarbon group having one or more carbon atoms, and one or more —CH₂—'s constituting the aliphatic hydrocarbon group may be substituted with —CO—, —O—, —S—, —NH—, or —N(Q)-. Q represents a substituent. X represents a predetermined acid-cleavable group.

### CROSS-REFERENCE TO RELATED APPLICATIONS

This application is a Continuation of PCT International Application No. PCT/JP2024/021859 filed on Jun. 17, 2024, which claims priority under 35 U.S.C. § 119(a) to Japanese Patent Application No. 2023-118003 filed on Jul. 20, 2023. The above applications are hereby expressly incorporated by reference, in their entirety, into the present application.

### BACKGROUND OF THE INVENTION

### 1. Field of the Invention

The present invention relates to a liquid crystal composition, an optical absorption anisotropic film, a method of producing the optical absorption anisotropic film, an optical laminate, and an image display apparatus.

### 2. Description of the Related Art

In the past, devices which are operated by different principles for each function have been used in a case where an attenuation function, a polarization function, a scattering function, a shielding function, or the like is required in relation to irradiated light including laser light or natural light. Therefore, products corresponding to the above-described functions are also produced by production steps different for each function.

For example, in liquid crystal display (LCD), a linearly polarizing plate or a circularly polarizing plate is used to control optical activity and a birefringence property in displaying. In addition, in organic light emitting diodes (OLEDs), a circularly polarizing plate is used to prevent external light from being reflected.

In the related art, iodine has been widely used as a dichroic substance in these polarizing plates (polarizing elements). However, a polarizing element using an organic dye as a dichroic substance instead of iodine has also been examined.

For example, WO2020/122116A describes an optical absorption anisotropic film formed of a liquid crystal composition containing a polymer liquid crystal compound and a dichroic substance (claim 1).

### SUMMARY OF THE INVENTION

As a result of studying a liquid crystal composition and an optical absorption anisotropic film described in WO2020/122116A, the present inventors have found that there is room for improvement in achieving both solubility of the liquid crystal composition and alignment degree of the optical absorption anisotropic film.

Therefore, an object of the present invention is to provide a liquid crystal composition having excellent solubility and capable of producing an optical absorption anisotropic film having a high alignment degree, an optical absorption anisotropic film, a method of producing the optical absorption anisotropic film, an optical laminate, and an image display apparatus.

As a result of intensive studies on the above object, the present inventors have found that, by using a dichroic substance having a specific acid-cleavable group together with a liquid crystal compound, solubility of the liquid crystal composition is improved and the alignment degree of the produced optical absorption anisotropic film is also increased, and have completed the present invention.

That is, the present inventors have found that the above-described object can be achieved by employing the following configurations.

[1]A liquid crystal composition comprising:
a dichroic substance represented by Formula (1); and
a liquid crystal compound.

[2] The liquid crystal composition according to [1], in which
X in Formula (1) described later represents an acid-cleavable group represented by any of Formulae (A1) to (A5) described later.

[3] The liquid crystal composition according to [2], in which
X in Formula (1) described later represents the acid-cleavable group represented by Formula (A2) described later.

[4] The liquid crystal composition according to [3], in which
two R^{A2}'s in Formula (A2) described later each independently represent a linear or branched monovalent aliphatic hydrocarbon group.

[5] The liquid crystal composition according to [4], in which
a molecular weight of R^{A2} in Formula (A2) described later is 300 or less.

[6] The liquid crystal composition according to any one of [1] to [5], in which
n in Formula (1) described later represents an integer of two or more.

[7] The liquid crystal composition according to any one of [1] to [6], in which
the dichroic substance is represented by Formula (2) described later.

[8] The liquid crystal composition according to any one of [1] to [7], in which
a content of the dichroic substance is 4% to 80% by mass with respect to a total mass of solid contents of the liquid crystal composition.

[9] An optically anisotropic film obtained by fixing an alignment state of the liquid crystal composition according to any one of [1] to [8].

[10] The optical absorption anisotropic film according to [9], in which
the liquid crystal compound contained in the liquid crystal composition is obtained by fixing in a horizontally aligned state.

[11] The optical absorption anisotropic film according to [9] or [10], in which
an angle θ between a transmittance central axis of the optical absorption anisotropic film and a normal direction of a surface of the optical absorption anisotropic film is 0° or more and 450 or less.

[12]A method of producing an optical absorption anisotropic film according to any one of [9] to [11], comprising:
a coating film forming step of applying the liquid crystal composition according to any one of [1] to [8] to form a coating film;
a cleavage step of generating an acid in the coating film by light irradiation or heating after the coating film forming step to cleave an acid-cleavable group of the dichroic substance represented by Formula (1);
an alignment step of aligning the dichroic substance having the cleaved acid-cleavable group after the cleavage step; and
a curing step of obtaining by fixing an alignment state of the dichroic substance after the alignment step to obtain the optical absorption anisotropic film.

[13] An optical laminate comprising:
the optical absorption anisotropic film according to any one of [9] to [11].

[14] An image display apparatus comprising:
the optical absorption anisotropic film according to any one of [9] to [11].

As described below, according to the present invention, it is possible to provide a liquid crystal composition having excellent solubility and capable of producing an optical absorption anisotropic film having a high alignment degree, an optical absorption anisotropic film, a method of producing the optical absorption anisotropic film, an optical laminate, and an image display apparatus.

### DESCRIPTION OF THE PREFERRED EMBODIMENTS

Hereinafter, the present invention will be described in detail.

The description of configuration requirements described below may be made based on typical embodiments of the present invention, but the present invention is not limited to such embodiments.

In the present specification, a numerical range expressed using “to” means a range including numerical values before and after “to” as a lower limit value and an upper limit value.

In addition, in the present specification, an upper limit value or a lower limit value described in a certain numerical range in a numerical range described in a stepwise manner may be replaced with an upper limit value or a lower limit value in another numerical range described in a stepwise manner. In addition, regarding the numerical range described in the present specification, an upper limit value or a lower limit value described in a numerical value may be replaced with a value described in Examples.

In addition, in the present specification, substances corresponding to respective components may be used alone or in combination of two or more kinds thereof. Here, in a case where two or more kinds of substances are used in combination for each component, the content of the component indicates the total content of the substances used in combination, unless otherwise specified.

In addition, in the present specification, “(meth)acrylate” denotes “acrylate” or “methacrylate”, “(meth)acryl” denotes “acryl” or “methacryl”, and “(meth)acryloyl” denotes “acryloyl” or “methacryloyl”.

In addition, in the present specification, a bonding direction of a divalent group (for example, —O—CO—) described is not particularly limited, and for example, in a case where L² in an “L¹-L²-L³” bond is —O—CO—, and a bonding position on the L¹ side is represented by *1 and a bonding position on the L³ side is represented by *2, L² may be *1-O—CO—*2 or * 1-CO—O—*2.

In addition, in the present specification, Re(λ) and Rth(λ) respectively represent an in-plane retardation at a wavelength λ and a thickness-direction retardation at a wavelength λ. Unless otherwise specified, the wavelength λ refers to 550 nm.

In the present invention, Re(λ) and Rth(λ) are values measured at the wavelength of λ in AxoScan (manufactured by Axometrics, Inc.). By inputting an average refractive index ((nx+ny+nz)/3) and a film thickness (d (μm)) in AxoScan,
a slow axis direction (°),

$$Re ( λ ) = R 0 ( λ ) , and$$

$$Rth ( λ ) = ( ( nx + ny ) / 2 - nz ) \times d$$

are calculated.

Although R0 (λ) is displayed as a numerical value calculated by AxoScan, it means Re (λ).

In addition, in the present specification, examples of the substituent (monovalent substituent) include substituents described in a substituent group A described later.

In the present specification, “may have a substituent” includes not only an aspect of not having a substituent but also an aspect of having one or more substituents.

### <Substituent Group A>

Examples of the substituent include
a halogen atom (for example, a fluorine atom, a chlorine atom, or a bromine atom, preferably a chlorine atom or a fluorine atom, and more preferably a fluorine atom);
an alkyl group (a linear, branched, or cyclic alkyl group having preferably 1 to 48 carbon atoms, more preferably 1 to 24 carbon atoms, and particularly preferably 1 to 8 carbon atoms, such as a linear alkyl group having 1 to 6 carbon atoms (for example, a methyl group, an ethyl group, an n-propyl group, an n-butyl group, an n-pentyl group, and an n-hexyl group), a branched alkyl group having 3 to 6 carbon atoms (for example, an isopropyl group, an isobutyl group, a tert-butyl group, a sec-butyl group, a neopentyl group, an isohexyl group, and a 3-methylpentyl group), and a cyclic alkyl group having 3 to 12 carbon atoms (for example, a cyclopropyl group, a cyclopentyl group, a cyclohexyl group, a 1-norbornyl group, and a 1-adamantyl group));
an alkenyl group (an alkenyl group having preferably 2 to 48 carbon atoms and more preferably 2 to 18 carbon atoms, such as a vinyl group, an allyl group, a 1-butene group, and a 2-butene group);
an alkynyl group (an alkynyl group having preferably 2 to 6 carbon atoms and more preferably 2 to 4 carbon atoms, such as an ethynyl group, a 1-propynyl group, a propargyl group, a 1-butylnyl group, and a 2-butylnyl group);
an aryl group (an aryl group having preferably 6 to 48 carbon atoms and more preferably 6 to 24 carbon atoms, such as a phenyl group, an oligoaryl group (a naphthyl group or an anthryl group), a phenanthrenyl group, a fluorenyl group, a pyrenyl group, a triphenylenyl group, and a biphenyl group);
a heteroaryl group (a heterocyclic group having preferably 1 to 32 carbon atoms and more preferably 1 to 18 carbon atoms, such as a 2-thienyl group, a 4-pyridyl group, a 2-furyl group, a 2-pyrimidinyl group, a 1-pyridyl group, a 2-benzothiazolyl group, a 1-imidazolyl group, a 1-pyrazolyl group, and a benzotriazol-1-yl group);
an arylalkyl group (an arylalkyl group having preferably 7 to 15 carbon atoms, such as a benzyl group, a phenethyl group, a methylbenzyl group, a phenylpropyl group, a 1-methylphenylethyl group, a phenylbutyl group, a 2-methylphenylpropyl group, a tetrahydronaphthyl group, a naphthylmethyl group, a naphthylethyl group, an indenyl group, a fluorenyl group, an anthracenylmethyl group (an anthrylmethyl group), and a phenanthrenylmethyl group (a phenanthrylmethyl group));
a silyl group (a silyl group having preferably 3 to 38 carbon atoms and more preferably 3 to 18 carbon atoms, such as a trimethylsilyl group, a triethylsilyl group, a tributylsilyl group, a t-butyldimethylsilyl group, and a t-hexyldimethylsilyl group);
a hydroxy group; a cyano group; a nitro group; a morpholino group;
an alkoxy group (an alkoxy group having preferably 1 to 48 carbon atoms and more preferably 1 to 24 carbon atoms, such as a methoxy group, an ethoxy group, a 1-butoxy group, a 2-butoxy group, an isopropoxy group, a t-butoxy group, a dodecyloxy group, and a cycloalkyloxy group (for example, a cyclopentyloxy group or a cyclohexyloxy group));
an aryloxy group (an aryloxy group having preferably 6 to 48 carbon atoms and more preferably 6 to 24 carbon atoms, such as a phenoxy group and a 1-naphthoxy group);
an alkenyloxy group (an alkenyloxy group having preferably 2 to 6 carbon atoms, such as a vinyloxy group, a 1-propenyloxy group, a 2-n-propenyloxy group (an allyloxy group), a 1-n-butenyloxy group, and a prenyloxy group);
a heterocyclic oxy group (a heterocyclic oxy group having preferably 1 to 32 carbon atoms and more preferably 1 to 18 carbon atoms, such as a 1-phenyltetrazole-5-oxy group and a 2-tetrahydropyranyloxy group);
a silyloxy group (a silyloxy group having preferably 1 to 32 carbon atoms and more preferably 1 to 18 carbon atoms, such as a trimethylsilyloxy group, a t-butyldimethylsilyloxy group, and a diphenylmethylsilyloxy group);
an acyloxy group (an acyloxy group having preferably 2 to 48 carbon atoms and more preferably 2 to 24 carbon atoms, such as an acetoxy group, a pivaloyloxy group, a benzoyloxy group, a dodecanoyloxy group, an acryloyloxy group, and a methacryloyloxy group);
a hydroxyalkyleneoxy group (a hydroxyalkyleneoxy group having preferably 2 to 10 carbon atoms, such as a hydroxyethyleneoxy group);
an alkoxycarbonyloxy group (an alkoxycarbonyloxy group having preferably 2 to 48 carbon atoms and more preferably 2 to 24 carbon atoms, such as an ethoxycarbonyloxy group, a t-butoxycarbonyloxy group, and a cycloalkyloxycarbonyloxy group (for example, a cyclohexyloxycarbonyloxy group));
an aryloxycarbonyloxy group (an aryloxycarbonyloxy group having preferably 7 to 32 carbon atoms and more preferably 7 to 24 carbon atoms, such as a phenoxycarbonyloxy group);
a carbamoyloxy group (a carbamoyloxy group having preferably 1 to 48 carbon atoms and more preferably 1 to 24 carbon atoms, such as an N,N-dimethylcarbamoyloxy group, an N-butylcarbamoyloxy group, an N-phenylcarbamoyloxy group, and an N-ethyl-N-phenylcarbamoyloxy group);
a sulfamoyloxy group (a sulfamoyloxy group having preferably 1 to 32 carbon atoms and more preferably 1 to 24 carbon atoms, such as an N,N-diethylsulfamoyloxy group and an N-propylsulfamoyloxy group);
an alkylsulfonyloxy group (an alkylsulfonyloxy group having preferably 1 to 38 carbon atoms and more preferably 1 to 24 carbon atoms, such as a methylsulfonyloxy group, a hexadecylsulfonyloxy group, and a cyclohexylsulfonyloxy group);
an arylsulfonyloxy group (an arylsulfonyloxy group having preferably 6 to 32 carbon atoms and more preferably 6 to 24 carbon atoms, such as a phenylsulfonyloxy group);
an acyl group (an acyl group having preferably 1 to 48 carbon atoms and more preferably 1 to 24 carbon atoms, such as a formyl group, an acetyl group, an acryloyl group, a methacryloyl group, a pivaloyl group, a benzoyl group, a tetradecanoyl group, and a cyclohexanoyl group);
an alkoxycarbonyl group (an alkoxycarbonyl group having preferably 2 to 48 carbon atoms and more preferably 2 to 24 carbon atoms, such as a methoxycarbonyl group, an ethoxycarbonyl group, an octadecyloxycarbonyl group, a cyclohexyloxycarbonyl group, and a 2,6-di-tert-butyl-4-methylcyclohexyloxycarbonyl group);
an aryloxycarbonyl group (an aryloxycarbonyl group having preferably 7 to 32 carbon atoms and more preferably 7 to 24 carbon atoms, such as a phenoxycarbonyl group);
a carbamoyl group (a carbamoyl group having preferably 1 to 48 carbon atoms and more preferably 1 to 24 carbon atoms, such as a carbamoyl group, an N,N-diethylcarbamoyl group, an N-ethyl-N-octylcarbamoyl group, an N,N-dibutylcarbamoyl group, an N-propylcarbamoyl group, an N-phenylcarbamoyl group, an N-methyl-N-phenylcarbamoyl group, and an N,N-dicyclohexylcarbamoyl group);
an amino group (preferably an amino group having 32 or less carbon atoms, more preferably an amino group having 24 or less carbon atoms, for example, an amino group, a methylamino group, an N,N-dimethylamino group, an N,N-dibutylamino group, a tetradecylamino group, a 2-ethylhexylamino group, or a cyclohexylamino group);
an anilino group (an anilino group having preferably 6 to 32 carbon atoms and more preferably 6 to 24 carbon atoms, such as an anilino group and an N-methylanilino group);
a heterocyclic amino group (a heterocyclic amino group having preferably 1 to 32 carbon atoms and more preferably 1 to 18 carbon atoms, such as a 4-pyridylamino group);
a carbonamide group (a carbonamide group having preferably 2 to 48 carbon atoms and more preferably 2 to 24 carbon atoms, such as an acetamide group, a benzamide group, a tetradecaneamide group, a pivaloylamide group, and a cyclohexaneamide group);
a ureido group (a ureido group having preferably 1 to 32 carbon atoms and more preferably 1 to 24 carbon atoms, such as a ureido group, an N,N-dimethylureido group, and an N-phenylureido group);
an imide group (an imide group having preferably 36 or less carbon atoms and more preferably 24 or less carbon atoms, such as an N-succinimide group and an N-phthalimide group);
an alkoxycarbonylamino group (an alkoxycarbonylamino group having preferably 2 to 48 carbon atoms and more preferably 2 to 24 carbon atoms, such as a methoxycarbonylamino group, an ethoxycarbonylamino group, a t-butoxycarbonylamino group, an octadecyloxycarbonylamino group, and a cyclohexyloxycarbonylamino group);
an aryloxycarbonylamino group (an aryloxycarbonylamino group having preferably 7 to 32 carbon atoms and more preferably 7 to 24 carbon atoms, such as a phenoxycarbonylamino group);
a sulfonamide group (a sulfonamide group having preferably 1 to 48 carbon atoms and more preferably 1 to 24 carbon atoms, such as a methanesulfonamide group, a butanesulfonamide group, a benzenesulfonamide group, a hexadecanesulfonamide group, and a cyclohexanesulfonamide group);
a sulfamoylamino group (a sulfamoylamino group having preferably 1 to 48 carbon atoms and more preferably 1 to 24 carbon atoms, such as an N,N-dipropylsulfamoylamino group and an N-ethyl-N-dodecylsulfamoylamino group);
an azo group (an azo group having preferably 1 to 32 carbon atoms and more preferably 1 to 24 carbon atoms, such as a phenylazo group and a 3-pyrazolylazo group);
an alkylthio group (an alkylthio group having preferably 1 to 48 carbon atoms and more preferably 1 to 24 carbon atoms, such as a methylthio group, an ethylthio group, an octylthio group, and a cyclohexylthio group);
an arylthio group (an arylthio group having preferably 6 to 48 carbon atoms and more preferably 6 to 24 carbon atoms, such as a phenylthio group);
a heterocyclic thio group (a heterocyclic thio group having preferably 1 to 32 carbon atoms and more preferably 1 to 18 carbon atoms, such as a 2-benzothiazolylthio group, a 2-pyridylthio group, and a 1-phenyltetrazolylthio group);
an alkylsulfinyl group (an alkylsulfinyl group having preferably 1 to 32 carbon atoms and more preferably 1 to 24 carbon atoms, such as a dodecanesulfinyl group);
an arylsulfinyl group (an arylsulfinyl group having preferably 6 to 32 carbon atoms and more preferably 6 to 24 carbon atoms, such as a phenylsulfinyl group);
an alkylsulfonyl group (an alkylsulfonyl group having preferably 1 to 48 carbon atoms and more preferably 1 to 24 carbon atoms, such as a methylsulfonyl group, an ethylsulfonyl group, a propylsulfonyl group, a butylsulfonyl group, an isopropylsulfonyl group, a 2-ethylhexylsulfonyl group, a hexadecylsulfonyl group, an octylsulfonyl group, and a cyclohexylsulfonyl group);
an arylsulfonyl group (an arylsulfonyl group having preferably 6 to 48 carbon atoms and more preferably 6 to 24 carbon atoms, such as a phenylsulfonyl group and a 1-naphthylsulfonyl group);
a sulfamoyl group (a sulfamoyl group having preferably 32 or less carbon atoms and more preferably 24 or less carbon atoms, such as a sulfamoyl group, an N,N-dipropylsulfamoyl group, an N-ethyl-N-dodecylsulfamoyl group, an N-ethyl-N-phenylsulfamoyl group, an N-cyclohexylsulfamoyl group, and an N-(2-ethylhexyl)sulfamoyl group);
a phosphonyl group (a phosphonyl group having preferably 1 to 32 carbon atoms and more preferably 1 to 24 carbon atoms, such as a phenoxyphosphonyl group, an octyloxyphosphonyl group, and a phenylphosphonyl group);
a phosphinoylamino group (a phosphinoylamino group having preferably 1 to 32 carbon atoms and more preferably 1 to 24 carbon atoms, such as a diethoxyphosphinoylamino group and a dioctyloxyphosphinoylamino group);
epoxy group; —NHCOCH₃; —SO₂NH C₂H₄OCH₃; and —NHSO₂CH₃;
in which two or more thereof may be combined.

These substituents may be further substituted with these substituents. In addition, in a case of having two or more of the substituents, the substituents may be the same or different from each other. Further, these may be bonded to each other to form a ring where possible.

### [Liquid Crystal Composition]

The liquid crystal composition according to the present invention is a liquid crystal composition containing a dichroic substance represented by Formula (1) and a liquid crystal compound.

In the present invention, as described above, by using the dichroic substance represented by Formula (1) described later together with the liquid crystal compound, the solubility of the liquid crystal composition is improved, and the alignment degree of the produced optical absorption anisotropic film is also increased.

The reason why this effect is exhibited is not clear in detail, but the present inventors have presumed as follows.

First, it is considered that the acid-cleavable group of the dichroic substance represented by Formula (1) described later, that is, the acid-cleavable group represented by any of Formulae (A1) to (A6) described later is a flexible substituent or a bulky substituent, so that the crystallization of the dichroic substance is suppressed, and the solubility of the liquid crystal composition is improved.

In addition, it is considered that, in a case of producing the optical absorption anisotropic film, specifically, by performing a treatment of cleaving the acid-cleavable group on the coating film formed by applying the liquid crystal composition, the flexible substituent or the bulky substituent is eliminated, so that the crystallization of the dichroic substance is promoted, and the alignment degree of the produced optical absorption anisotropic film is improved.

Hereinafter, the dichroic substance and the liquid crystal compound contained in the liquid crystal composition according to the present invention, and any optional component will be described in detail.

### [Dichroic Substance]

### <Dichroic Substance Represented by Formula (1)>

The liquid crystal composition according to the present invention contains a dichroic substance represented by Formula (1).

Here, the dichroic substance means a coloring agent having different absorbances depending on the direction.

In addition, the dichroic substance may or may not exhibit liquid crystallinity.

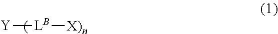

In Formula (1), Y represents an n-valent coloring agent skeleton structure.

Here, the coloring agent skeleton structure means a “structure having a maximal absorption wavelength in a visible light region (in a wavelength range of 380 nm to 780 nm)”. The maximal absorption wavelength can be calculated from an obtained absorption spectrum by measuring the absorbance in the visible light region using an ultraviolet-visible spectrophotometer (for example, UV-1800 (manufactured by Shimadzu Corporation)).

Suitable examples of such a coloring agent skeleton structure include a structure of a portion excluding -(L^{B}-X) in a structure of the dichroic substance represented by Formula (2) described later.

In Formula (1), n represents an integer of one or more.

In the present invention, from the reason that the alignment degree of the produced optical absorption anisotropic film is further increased, n is preferably an integer of two or more, more preferably an integer of 2 to 4, still more preferably 2 or 3, and particularly preferably 2.

In Formula (1), L^{B} represents a divalent aliphatic hydrocarbon group having one or more carbon atoms, and one or more —CH₂-'s constituting the aliphatic hydrocarbon group may be substituted with —CO—, —O—, —S—, —NH—, or —N(Q)-. Q represents a substituent. Provided that in a case where n represents an integer of two or more, a plurality of L^{b}'s may be the same as or different from each other.

Here, examples of the divalent aliphatic hydrocarbon group having one or more carbon atoms include a linear or branched alkylene group having 1 to 20 carbon atoms, a linear or branched alkenylene group having 1 to 20 carbon atoms, and a linear or branched alkynylene group having 1 to 20 carbon atoms.

As the linear or branched alkylene group having 1 to 20 carbon atoms, an alkylene group having 1 to 12 carbon atoms is preferable and an alkylene group having 1 to 10 carbon atoms is more preferable; and suitable examples thereof include a methylene group, an ethylene group, a propylene group, a butylene group, a pentylene group, and a hexylene group.

As the linear or branched alkenylene group having 1 to 20 carbon atoms, an alkenylene group having 2 to 10 carbon atoms is preferable and an alkenylene group having 2 to 4 carbon atoms is more preferable; and suitable examples thereof include an ethenylene group.

As the linear or branched alkynylene group having 1 to 20 carbon atoms, an alkynylene group having 2 to 10 carbon atoms is preferable and an alkynylene group having 2 to 4 carbon atoms is more preferable; and suitable examples thereof include an ethynylene group.

As described above, one or more of —CH₂—'s constituting the aliphatic hydrocarbon group may be substituted with —O—, —S—, —NH—, —N(Q)-, or —CO—; and examples of the substituent represented by Q include the substituents described in the substituent group A above. Among these, an alkyl group, an alkoxy group, an alkoxycarbonyl group, an alkylcarbonyloxy group, or a halogen atom is preferable.

In Formula (1), X represents an acid-cleavable group represented by any of Formulae (A1) to (A6). Provided that in a case where n represents an integer of two or more, a plurality of X's may be the same as or different from each other. In Formulae (A1) to (A6), * represents a bonding position to L^{B}.

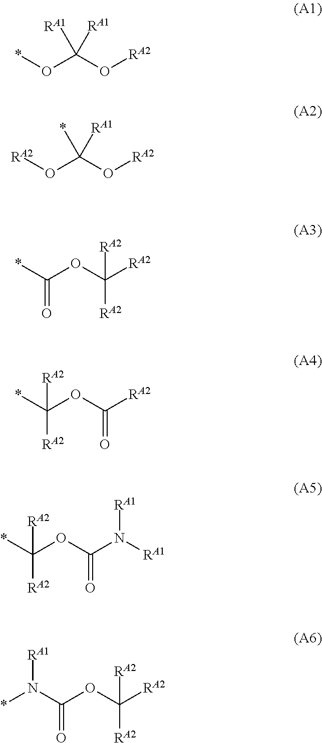

In Formulae (A1) to (A6), R^{A1} represents a hydrogen atom or a monovalent hydrocarbon group, and a part of hydrogen atoms of the hydrocarbon group may be substituted with a halogen atom, and a part of carbon atoms may be substituted with silicon or oxygen. However, two R^{A1}'s in Formulae (A1) and (A5) may be the same or different from each other, and may be bonded to each other to form a ring.

In addition, R^{A2} represents a monovalent hydrocarbon group, and a part of hydrogen atoms of the hydrocarbon group may be substituted with a halogen atom, and a part of carbon atoms may be substituted with silicon or oxygen. However, a plurality of R^{A2}'s in Formulae (A2) to (A6) may be the same or different from each other, and may be bonded to each other to form a ring.

Here, examples of one aspect of R^{A1} and the monovalent hydrocarbon group represented by R^{A2} include a monovalent chain-like hydrocarbon group, a monovalent alicyclic hydrocarbon group, and a monovalent aromatic hydrocarbon group.

Examples of the monovalent chain-like hydrocarbon group include an alkyl group such as a methyl group, an ethyl group, a propyl group, and a butyl group; an alkenyl group such as an ethenyl group, a propenyl group, and a butenyl group; and an alkynyl group such as an ethynyl group, a propynyl group, and a butynyl group.

Examples of the monovalent alicyclic hydrocarbon group include a cycloalkyl group such as a cyclopropyl group, a cyclobutyl group, a cyclopentyl group, a cyclohexyl group, a norbornyl group, and an adamantyl group; and a cycloalkenyl group such as a cyclopropenyl group, a cyclobutenyl group, a cyclopentenyl group, and a norbornenyl group.

Examples of monovalent aromatic hydrocarbon groups include a phenyl group, a tolyl group, a xylyl group, a mesityl group, a naphthyl group, a methylnaphthyl group, an anthryl group, and a methylanthryl group; and aralkyl groups such as a benzyl group, a phenethyl group, a phenylpropyl group, a naphthylmethyl group, and an anthrylmethyl group.

Among these, a monovalent chain-like hydrocarbon group is preferable, and an alkyl group is more preferable.

In addition, examples of an aspect in which a part of hydrogen atoms of the hydrocarbon group is substituted with a halogen atom in one aspect of R^{A1} and the monovalent hydrocarbon group represented by R^{A2} include a fluorinated alkyl group in which a part of hydrogen atoms of an alkyl group is substituted with a fluorine atom, and specific examples thereof include —(CH₂)ₘ₁(CF₂)ₘ₂CF₂X. m1 and m2 each independently represent an integer of 0 to 19, and X represents a hydrogen atom or a fluorine atom. In addition, m1 is preferably an integer of 1 to 10, and m2 is preferably an integer of 0 to 9.

Similarly, examples of an aspect in which a part of carbon atoms is substituted with silicon or oxygen include an aspect in which a part of carbon atoms of an alkyl group is substituted with silicon or oxygen, and specific examples thereof include —(CH₂)ₘ₃Si(CH₃)₃ and —(CH₂)ₘ₃Si(OSi(CH₃)₃)₃. m3 represents an integer of 1 to 10.

In the present invention, from the reason that the alignment degree of the produced optical absorption anisotropic film is further increased, X in Formula (1) preferably represents the acid-cleavable group represented by any of Formulae (A1) to (A5), and more preferably represents the acid-cleavable group represented by Formula (A2).

In addition, in the present invention, from the reason that the solubility of the liquid crystal composition is further improved, it is preferable that two R^{A2}'s in Formula (A2) each independently represent a linear or branched monovalent aliphatic hydrocarbon group. That is, it is preferable that two R^{A2}'s in Formula (A2) are not bonded to each other to form a ring.

Here, examples of the linear monovalent aliphatic hydrocarbon group include a linear alkyl group having 1 to 6 carbon atoms such as a methyl group, an ethyl group, an n-propyl group, an n-butyl group, an n-pentyl group, and an n-hexyl group.

In addition, examples of the branched monovalent aliphatic hydrocarbon group include a branched alkyl group having 3 to 6 carbon atoms such as an isopropyl group, an isobutyl group, a tert-butyl group, a sec-butyl group, a neopentyl group, an isohexyl group, and a 3-methylpentyl group.

Furthermore, in the present invention, from the reason that the alignment degree of the produced optical absorption anisotropic film is further increased, a molecular weight of R^{A2} in Formula (A2) is preferably 300 or less and more preferably 10 to 150.

Suitable examples of the dichroic substance represented by Formula (1) include a compound represented by Formula (2).

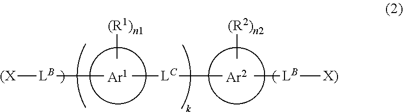

In Formula (2), X and L^{B} have the same definitions as those in Formula (1). However, two X's may be the same or different from each other, and two L^{B}'s may be the same or different from each other.

In Formula (2), n1, and n2 each independently represent an integer of 0 to 4.

Here, n1 and n2 are each independently preferably an integer of 0 to 2 and more preferably 0 or 1.

In Formula (2), k represents an integer of 1 to 4.

Here, k is preferably an integer of 2 to 4 and more preferably 2 or 3.

In Formula (2), Ar¹ represents an (n1+2)-valent aromatic hydrocarbon group or an (n1+2)-valent heterocyclic group. However, in a case where k represents an integer of 2 to 4, a plurality of Ar¹'s may be the same or different from each other.

Here, examples of the (n1+2)-valent aromatic hydrocarbon group include a group obtained by removing a number of hydrogen atoms corresponding to the valence from an aromatic hydrocarbon ring, that is, a number of hydrogen atoms bonded to a carbon atom constituting the aromatic hydrocarbon ring.

Similarly, examples of the (n1+2)-valent heterocyclic group include a group obtained by removing a number of hydrogen atoms corresponding to the valence from a heterocyclic ring, that is, a number of hydrogen atoms bonded to a carbon atom or a heteroatom constituting the heterocyclic ring.

Examples of the aromatic hydrocarbon ring include a benzene ring, a naphthalene ring, an anthracene ring, and a phenanthroline ring.

In addition, examples of the heterocyclic ring include a furan ring, a pyrrole ring, a thiophene ring, a pyridine ring, a thiazole ring, a benzothiazole ring, and the like.

In Formula (2), Ar² represents an (n2+2)-valent aromatic hydrocarbon group or an (n2+2)-valent heterocyclic group.

Here, examples of the aromatic hydrocarbon group and the heterocyclic group include the same groups as those described in Ar¹.

In Formula (2), R¹ and R² each independently represent a substituent. However, in a case where n1 represents an integer of 2 to 4, a plurality of R¹'s may be the same or different from each other, and in a case where n2 represents an integer of 2 to 4, a plurality of R²'s may be the same or different from each other.

Here, examples of the substituent include the substituents described in the substituent group A described above, and among these, an alkyl group or a halogen atom is preferable.

In Formula (2), L^{C} represents —N═N—, —N═CY—, —CY═CY—, —OCO—, —SCO—, or —NHCO—, and Y represents a substituent. However, in a case where k represents an integer of 2 to 4, a plurality of L^{C}'s may be the same or different from each other.

Examples of the substituent represented by Y include the substituents described in the substituent group A above; and among these, an alkyl group, an alkoxy group, an alkoxycarbonyl group, an alkylcarbonyloxy group, or a halogen atom is preferable.

Suitable examples of the dichroic substance represented by Formula (1), in particular, the compound represented by Formula (2) include compounds represented by Formulae B-1 to B-15. In the following formulae, Me represents a methyl group, and TMS represents a trimethylsilyl group (—Si(CH₃)₃).

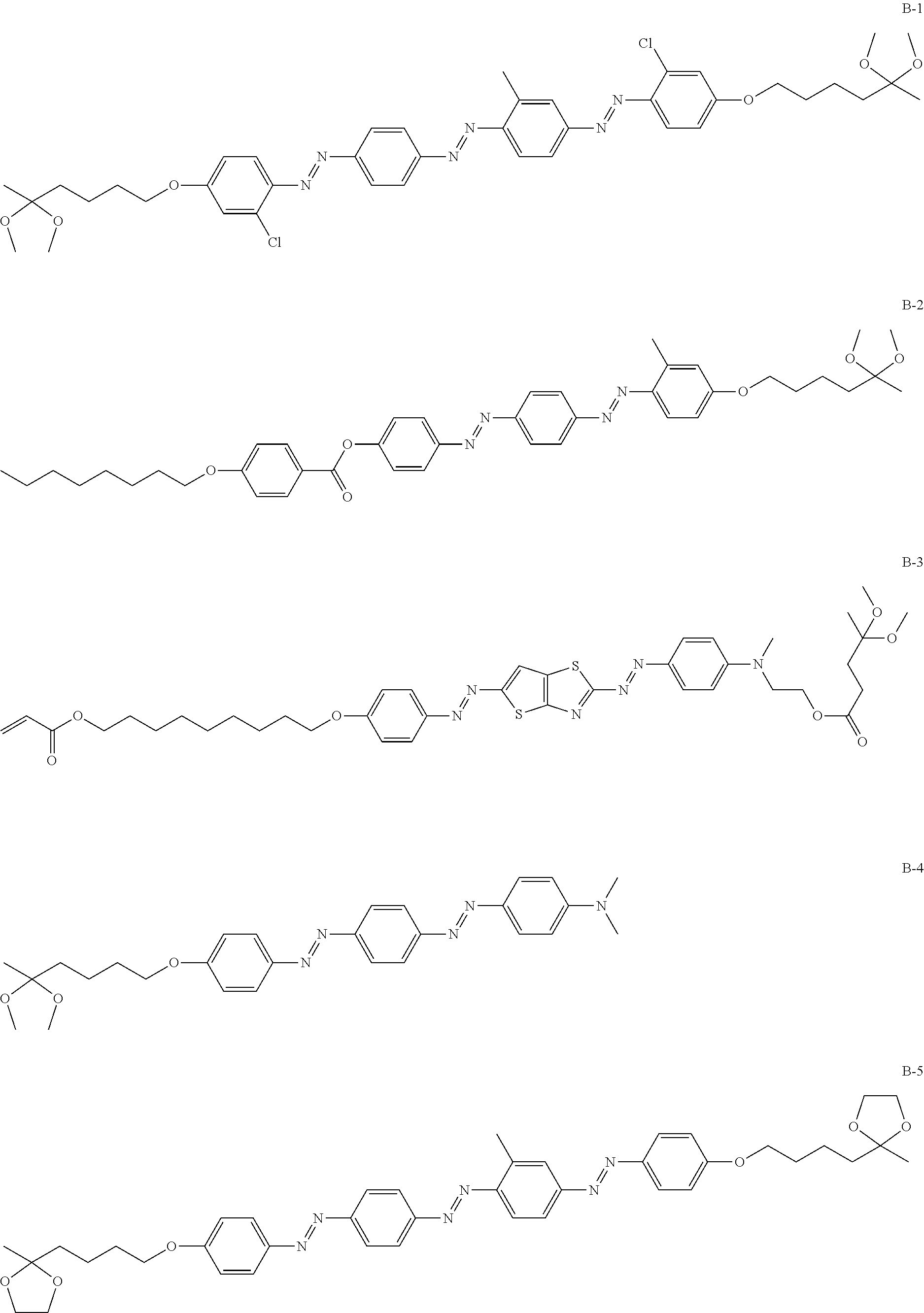

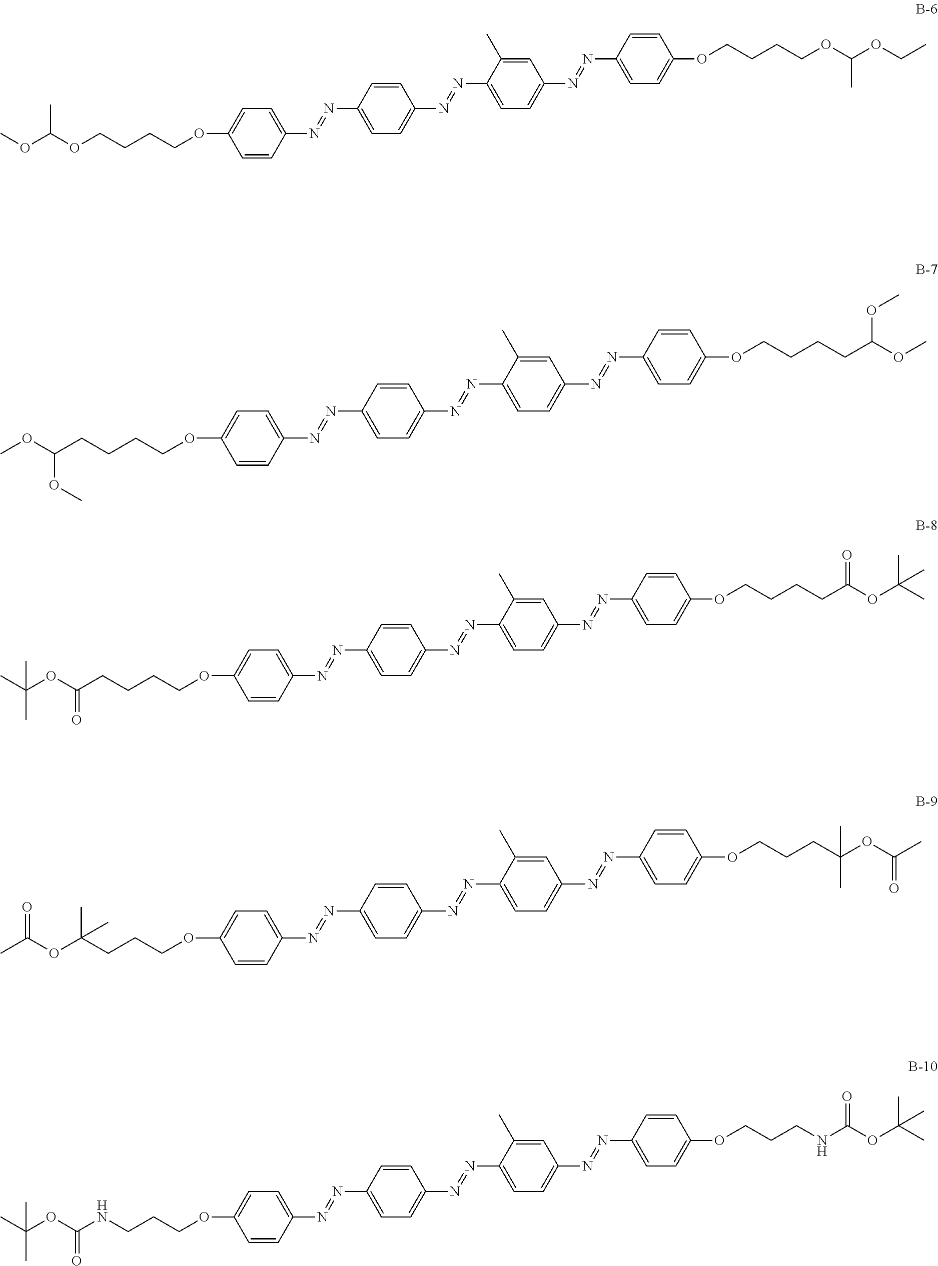

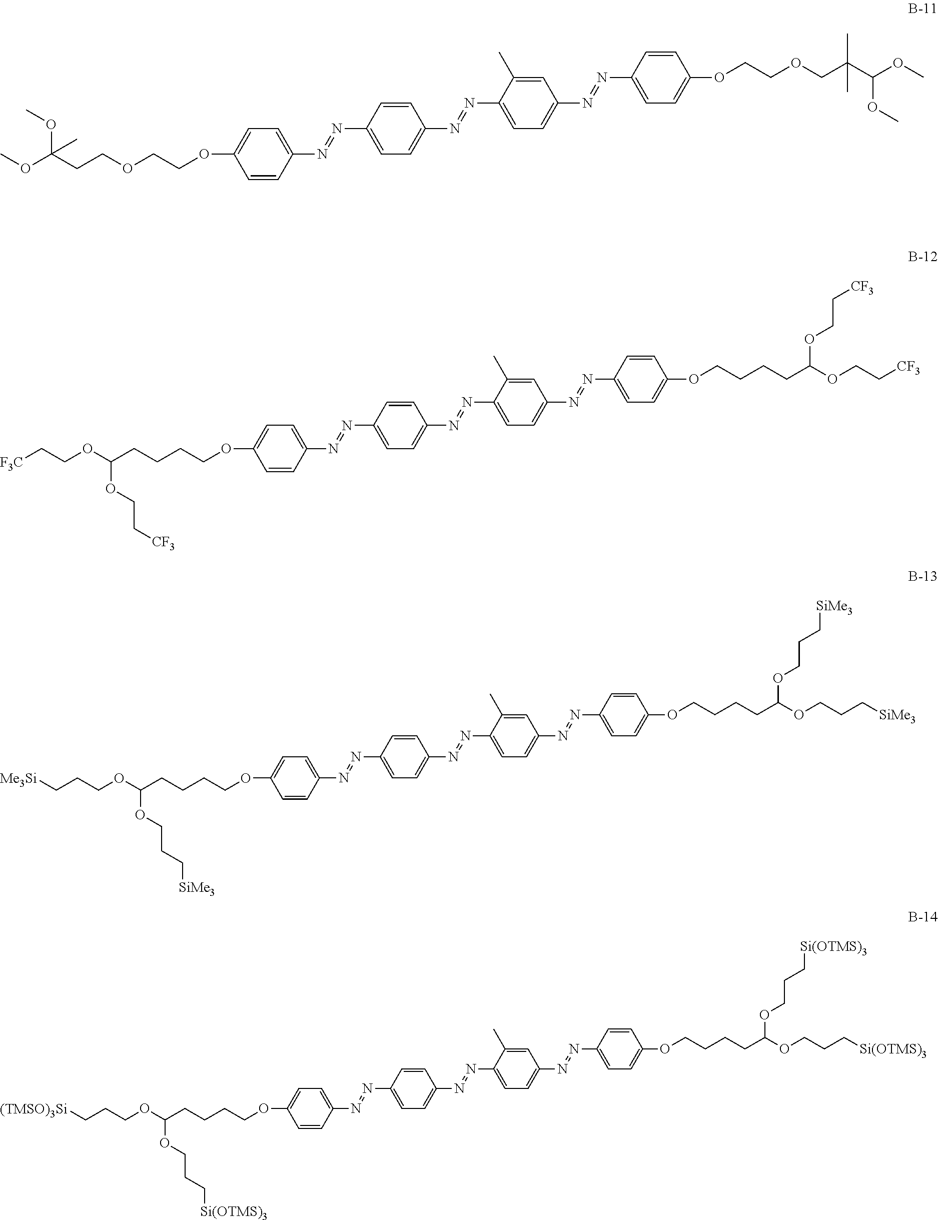

In the present invention, a content of the dichroic substance represented by Formula (1) is preferably 400 to 80% by mass, more preferably 5% to 400% by mass, and still more preferably 6% to 20% by mass with respect to the total mass of solid contents of the liquid crystal composition.

### <Other Dichroic Substances>

The liquid crystal composition according to the present invention may contain other dichroic substances in addition to the dichroic substance represented by Formula (1).

The other dichroic substances are not particularly limited, and examples thereof include a visible light absorbing material (dichroic coloring agent), a light emitting material (such as a fluorescent material or a phosphorescent material), an ultraviolet absorbing material, an infrared absorbing material, a non-linear optical material, a carbon nanotube, and an inorganic material (for example, a quantum rod). Further, known dichroic substances (dichroic coloring agents) of the related art can be used.

Specific examples thereof include those described in paragraphs [0067] to [0071] of JP2013-228706A, paragraphs [0008] to [0026] of JP2013-227532A, paragraphs [0008] to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] of JP2013-37353A, paragraphs [0049] to [0073] of JP2012-63387A, paragraphs [0016] to [0018] of JP1999-305036A (JP-H₁₁-305036A), paragraphs [0009] to [0011] of JP2001-133630A, paragraphs [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011-213610A, paragraphs [0074] to [0246] of JP2011-237513A, paragraphs [0005] to [0051] of JP2016-006502A, paragraphs [0014] to [0032] of JP2018-053167A, paragraphs [0014] to [0033] of JP2020-11716A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, paragraphs [0014] to [0034] of WO2018/164252A, paragraphs [0021] to [0030] of WO2018/186503A, paragraphs [0043] to [0063] of WO2019/189345A, paragraphs [0043] to [0085] of WO2019/225468A, paragraphs [0050] to [0074] of WO2020/004106A, and paragraphs [0015] to [0038] of WO2021/044843A.

As the other dichroic substance, a dichroic azo coloring agent compound is preferable.

The dichroic azo coloring agent compound denotes an azo coloring agent compound having different absorbances depending on the direction. The dichroic azo coloring agent compound may or may not exhibit liquid crystallinity. In a case where the dichroic azo coloring agent compound exhibits liquid crystallinity, any of nematic properties or smectic properties may be exhibited. The temperature range in which the liquid crystal phase is exhibited is preferably room temperature (approximately 20° C. to 28° C.) to 300° C., and from the viewpoints of handleability and production suitability, more preferably 50° C. to 200° C.

In the present invention, from the viewpoint of tint adjustment, it is preferable to use at least one coloring agent compound (first dichroic azo coloring agent compound) having a maximal absorption wavelength in a wavelength range of 560 to 700 nm and at least one coloring agent compound (second dichroic azo coloring agent compound) having a maximal absorption wavelength in a wavelength range of 455 nm or more and less than 560 nm.

In the present invention, three or more dichroic azo coloring agent compounds may be used in combination. For example, from the viewpoint of making the light absorption anisotropic film close to black, it is preferable to use the first dichroic azo coloring agent compound, the second dichroic azo coloring agent compound, and at least one coloring agent compound (third dichroic azo coloring agent compound) having a maximal absorption wavelength in a wavelength range of 380 nm or more and less than 455 nm in combination.

In the present invention, the dichroic azo coloring agent compound preferably has a crosslinkable group.

Examples of the crosslinkable group include a (meth)acryloyl group, an epoxy group, an oxetanyl group, and a styryl group, and among these, a (meth)acryloyl group is preferable.

A content of the other dichroic substances is not particularly limited, but is preferably 10% to 80% by mass, more preferably 15% to 60% by mass, and still more preferably 20% to 40% by mass with respect to the total mass of solid contents of the liquid crystal composition.

### [Liquid Crystal Compound]

The liquid crystal composition according to the present invention contains a liquid crystal compound. In this manner, the dichroic substance can be aligned with a higher alignment degree while the precipitation of the dichroic substance is suppressed.

Both a polymer liquid crystal compound and a low-molecular-weight liquid crystal compound can be used as the liquid crystal compound, and a polymer liquid crystal compound is preferable from the viewpoint that the alignment degree can be increased. Further, a polymer liquid crystal compound and a low-molecular-weight liquid crystal compound may be used in combination as the liquid crystal compound.

Here, the “polymer liquid crystal compound” refers to a liquid crystal compound having a repeating unit in the chemical structure.

In addition, the “low-molecular-weight liquid crystal compound” refers to a liquid crystal compound having no repeating unit in the chemical structure.

Examples of the polymer liquid crystal compound include thermotropic liquid crystal polymers described in JP2011-237513A and polymer liquid crystal compounds described in paragraphs [0012] to [0042] of WO2018/199096A.

Examples of the low-molecular-weight liquid crystal compound include liquid crystal compounds described in paragraphs [0072] to [0088] of JP2013-228706A, and among these, a liquid crystal compound exhibiting smectic properties is preferable.

Examples of such a liquid crystal compound include compounds described in paragraphs [0019] to [0140] of WO2022/014340A, the description of which is incorporated herein by reference.

It is preferable that the liquid crystal compound is a liquid crystal compound that does not exhibit dichroism in the visible light region.

A content of the liquid crystal compound is preferably 25 to 2,000 parts by mass, more preferably 100 to 1,300 parts by mass, and still more preferably 200 to 900 parts by mass with respect to 100 parts by mass of the content of the above-described dichroic substance (including the content in a case where the other dichroic substances are contained). In a case where the content of the liquid crystal compound is within the above-described range, the alignment degree of the dichroic substance is further improved.

The light absorption anisotropic layer may contain only one or two or more kinds of liquid crystal compounds. In a case of containing two or more kinds of liquid crystal compounds, the above-described content of the liquid crystal compound means the total content of the liquid crystal compounds.

### [Acid Generator]

### <Thermal Acid Generator>

In the liquid crystal composition according to the present invention, it is preferable that a thermal acid generator is contained from the reason that it is easy to cleave the acid-cleavable group of the dichroic substance represented by Formula (1) in a case of producing the optical absorption anisotropic film, specifically, on the coating film formed by applying the liquid crystal composition.

The thermal acid generator is not particularly limited as long as it is a compound that generates an acid by heat, and examples thereof include onium salts such as a sulfonium salt, an ammonium salt, and a phosphonium salt, and ester compounds such as a carboxylic acid ester compound, a sulfonic acid ester compound, and a phosphoric acid ester compound.

Examples of the acid generated from the thermal acid generator by heating include a sulfonic acid, a phosphoric acid, and a carboxylic acid, and a sulfonic acid is preferable and an aromatic sulfonic acid is more preferable.

A pKa of the acid generated from the thermal acid generator is preferably −15 to 3 and more preferably −10 to 0.

An acid generation temperature of the thermal acid generator is preferably 40° C. to 300° C., more preferably 80° C. to 260° C., still more preferably 100° C. to 220° C., and particularly preferably 120° C. to 200° C.

The acid generation temperature is determined as a peak temperature of a heat generation peak having the lowest temperature in a case where the thermal acid generator is heated to 500° C. at 5° C./min in a pressure-resistant capsule.

Examples of equipment used in measuring the acid generation temperature include Q2000 (manufactured by TA Instruments).

In addition, the acid generation temperature of the thermal acid generator is preferably lower than a boiling point of a solvent contained in the thermosetting photosensitive composition.

Suitable examples of a commercially available product of the thermal acid generator include SAN-EDO SI series manufactured by SANSHIN CHEMICAL INDUSTRY CO., LTD., CPI series manufactured by San-Apro Ltd., and K-PURE TAG series manufactured by King Chemicals Co., Ltd.

In addition, known thermal acid generators described in JP2003-277353A, JP1990-001470A (JP-H2-001470A), JP1990-255646A (JP-H2-255646A), JP1991-011044A (JP-H3-011044A), JP2003-183313A, JP2003-277352A, JP1983-037003A (JP-S58-037003A), JP1983-198532A (JP-S58-198532A), and the like can also be used.

In a case where the liquid crystal composition according to the present invention contains the thermal acid generator, a content of the thermal acid generator is preferably 1% to 10% by mass and more preferably 2% to 5% by mass with respect to the total mass of solid contents of the liquid crystal composition according to the present invention.

### <Photoacid Generator>

In the liquid crystal composition according to the present invention, it is preferable that a photoacid generator is contained from the reason that it is easy to cleave the acid-cleavable group of the dichroic substance represented by Formula (1) in a case of producing the optical absorption anisotropic film, specifically, on the coating film formed by applying the liquid crystal composition.

The photo-acid generator is not particularly limited, and is preferably a compound which is sensitive to actinic rays having a wavelength of 300 nm or more, preferably 300 to 450 nm, and generates an acid. A photo-acid generator which is not directly sensitive to actinic rays having a wavelength of 300 nm or more can also be preferably used in combination with a sensitizer as long as it is a compound which is sensitive to actinic rays having a wavelength of 300 nm or more and generates an acid by being used in combination with the sensitizer.

The photo-acid generator is preferably a photo-acid generator which generates an acid with a pKa of 4 or less, more preferably a photo-acid generator which generates an acid with a pKa of 3 or less, and even more preferably a photo-acid generator which generates an acid with a pKa of 2 or less. In the present invention, the pKa basically refers to a pKa in water at 25° C. With a compound which cannot be measured in water, the pKa refers to a pKa measured after changing to a solvent suitable for the measurement. Specifically, the pKa described in a chemical handbook or the like can be referred to. The acid with a pKa of 3 or less is preferably a sulfonic acid or a phosphonic acid, and more preferably a sulfonic acid.

Examples of the photo-acid generator include an onium salt compound, trichloromethyl-s-triazines, a sulfonium salt, an iodonium salt, quaternary ammonium salts, a diazomethane compound, an imidosulfonate compound, and an oxime sulfonate compound. Among these, an onium salt compound, an imidosulfonate compound, or an oxime sulfonate compound is preferable, and an onium salt compound or an oxime sulfonate compound is particularly preferable. The photo-acid generators can be used alone or in combination of two or more types thereof.

In a case where the liquid crystal composition according to the present invention contains the photoacid generator, a content of the photoacid generator is preferably 1% to 10% by mass and more preferably 2% to 5% by mass with respect to the total mass of solid contents of the liquid crystal composition according to the present invention.

### [Polymerization Initiator]

The liquid crystal composition according to the present invention may contain a polymerization initiator.

The polymerization initiator is not particularly limited, but a compound having photosensitivity, that is, a photopolymerization initiator is preferable.

As the photopolymerization initiator, various compounds can be used without any particular limitation. Examples of the photopolymerization initiator include α-carbonyl compounds (U.S. Pat. Nos. 2,367,661A and 2,367,670A), acyloin ether (U.S. Pat. No. 2,448,828A), α-hydrocarbon-substituted aromatic acyloin compounds (U.S. Pat. No. 2,722,512A), polynuclear quinone compounds (U.S. Pat. Nos. 3,046,127A and 2,951,758A), a combination of a triarylimidazole dimer and a p-aminophenyl ketone (U.S. Pat. No. 3,549,367A), acridine and phenazine compounds (JP1985-105667A (JP-S60-105667A) and U.S. Pat. No. 4,239,850A), oxadiazole compounds (U.S. Pat. No. 4,212,970A), o-acyloxime compounds ([0065] of JP2016-27384A), and acylphosphine oxide compounds (JP1988-40799B (JP-S63-40799B), JP1993-29234B (JP-H5-29234B), JP1998-95788A (JP-H10-95788A), and JP1998-29997A (JP-H10-29997A)).

Commercially available products can also be used as such a photopolymerization initiator, and examples thereof include IRGACURE-184, IRGACURE-907, IRGACURE-369, IRGACURE-651, IRGACURE-819, IRGACURE-OXE-01, and IRGACURE-OXE-02, manufactured by BASF SE.

In a case where the liquid crystal composition according to the present invention contains the polymerization initiator, a content of the polymerization initiator is preferably 0.01% to 30% by mass and more preferably 0.1% to 15% by mass with respect to the total mass of solid contents of the liquid crystal composition.

### [Solvent]

From the viewpoint of workability and the like, the liquid crystal composition according to the present invention preferably contains a solvent.

Examples of the solvent include organic solvents such as ketones (such as acetone, 2-butanone, methyl isobutyl ketone, cyclopentanone, cyclohexanone, or acetylacetone), ethers (such as dioxane, tetrahydrofuran, tetrahydropyran, dioxolane, tetrahydrofurfuryl alcohol, cyclopentyl methyl ether, or dibutyl ether), aliphatic hydrocarbons (such as hexane), alicyclic hydrocarbons (such as cyclohexane), aromatic hydrocarbons (such as benzene, toluene, xylene, tetralin, or trimethylbenzene), halogenated carbons (such as dichloromethane, trichloromethane (chloroform), dichloroethane, dichlorobenzene, 1,1,2,2-tetrachloroethane, or chlorotoluene), esters (such as methyl acetate, ethyl acetate, butyl acetate, diethyl carbonate, ethyl acetoacetate, n-pentyl acetate, ethyl benzoate, benzyl benzoate, butyl carbitol acetate, diethylene glycol monoethyl ether acetate, or isoamyl acetate), alcohols (such as ethanol, isopropanol, butanol, cyclohexanol, furfuryl alcohol, 2-ethylhexanol, octanol, benzyl alcohol, ethanolamine, ethylene glycol, propylene glycol, diethylene glycol, diethylene glycol monomethyl ether, diethylene glycol monoethyl ether, or diethylene glycol monobutyl ether), phenols (such as phenol or cresol), cellosolves (such as methyl cellosolve, ethyl cellosolve, or 1,2-dimethoxyethane), cellosolve acetates, sulfoxides (such as dimethyl sulfoxide), amides (such as dimethylformamide, dimethylacetamide, N-methylpyrrolidone, N-ethylpyrrolidone, or 1,3-dimethyl-2-imidazolidinone), and heterocyclic compounds (such as pyridine or 2,6-lutidine), and water.

These solvents may be used alone or in combination of two or more kinds thereof.

In a case where the liquid crystal composition according to the present invention contains a solvent, a content of the solvent is preferably 60% to 99.5% by mass, more preferably 70% to 99% by mass, and particularly preferably 75% to 98% by mass with respect to the total mass (100% by mass) of the liquid crystal composition.

### [Interface Improver]

The liquid crystal composition according to the present invention may contain an interface improving agent.

The interface improver is not particularly limited, and a polymer-based interface improver or a low-molecular-weight interface improver can be used, and compounds described in paragraphs [0253] to [0293] of JP2011-237513A can also be used.

In addition, a silicon-based polymer can be used as the interface improver.

In addition, fluorine (meth)acrylate-based polymers described in paragraphs [0018] to [0043] of JP2007-272185A can also be used as the interface improver.

In addition, examples of the interface improver include compound described in the description of paragraphs [0079] to [0102] of JP2007-069471A, polymerizable liquid crystal compounds represented by Formula (4) described in JP2013-047204A (particularly, compounds described in paragraphs [0020] to [0032]), polymerizable liquid crystal compounds represented by Formula (4) described in JP2012-211306A (particularly, compounds described in paragraphs [0022] to [0029]), liquid crystal alignment promoters represented by Formula (4) described in JP2002-129162A (particularly, compounds described in paragraphs [0076] to [0078] and paragraphs [0082] to [0084]), compounds represented by Formulae (4), (II), and (III) described in JP2005-099248A (particularly, compounds described in paragraphs [0092] to [0096]), compounds described in paragraphs [0013] to [0059] of JP4385997B, compounds described in paragraphs [0018] to [0044] of JP5034200B, and compounds described in paragraphs [0019] to [0038] of JP4895088B.

The interface improvers may be used alone or in combination of two or more kinds thereof.

In a case where the liquid crystal composition according to the present invention contains the interface improving agent, a content of the interface improving agent is preferably 0.005% to 15% by mass, more preferably 0.01% to 5% by mass, and still more preferably 0.015% to 3% by mass with respect to the total mass of solid contents of the liquid crystal composition. In a case where a plurality of interface improvers are used in combination, it is preferable that the total amount of the plurality of interface improvers is within the above-described range.

### [Alignment Agent]

The liquid crystal composition according to the present invention preferably contains an alignment agent.

Examples of the alignment agent include those described in paragraphs [0042] to [0076] of JP2013-543526A, paragraphs [0089] to [0097] of JP2016-523997A, paragraphs [0153] to [0170] of JP2020-076920A, and the like, and these may be used alone or in combination of two or more.

In the present invention, from the reason that the alignment degree of the formed light absorption anisotropic layer is increased, it is preferable that the above-described alignment agent is an onium compound represented by Formula (B1).

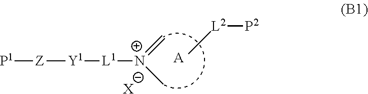

In Formula (B1), a ring A represents a quaternary ammonium ion consisting of a nitrogen-containing heterocyclic ring.

In addition, X represents an anion.

In addition, L¹ represents a divalent linking group.

In addition, L² represents a single bond or a divalent linking group.

In addition, Y¹ represents a divalent linking group having a 5-membered ring or a 6-membered ring as a partial structure.

In addition, Z represents a divalent linking group having an alkylene group having 2 to 20 carbon atoms as a partial structure.

In addition, P¹ and P² each independently represent a monovalent substituent having a polymerizable ethylenically unsaturated bond.

The ring A represents a quaternary ammonium ion consisting of a nitrogen-containing heterocyclic ring. Examples of the ring A include a pyridine ring, a picoline ring, a 2,2′-bipyridyl ring, a 4,4′-bipyridyl ring, a 1,10-phenanthroline ring, a quinoline ring, an oxazole ring, a thiazole ring, an imidazole ring, a pyrazine ring, a triazole ring, and a tetrazole ring, and the ring A is preferably a quaternary imidazolium ion or a quaternary pyridinium ion.

X represents an anion. Examples of X include a halogen anion (for example, a fluorine ion, a chlorine ion, a bromine ion, an iodine ion, and the like), a sulfonate ion (for example, a methanesulfonate ion, a trifluoromethanesulfonate ion, a methylsulfate ion, a vinylsulfonate ion, an allylsulfonate ion, a p-toluenesulfonate ion, a p-chlorobenzenesulfonate ion, a p-vinylbenzenesulfonate ion, a 1,3-benzenedisulfonate ion, a 1,5-naphthalenedisulfonate ion, a 2,6-naphthalenedisulfonate ion, and the like), a sulfate ion, a carbonate ion, a nitrate ion, a thiocyanate ion, a perchlorate ion, a tetrafluoroborate ion, a picrate ion, an acetate ion, a benzoate ion, a p-vinyl benzoate ion, a formate ion, a trifluoroacetate ion, a phosphate ion (for example, hexafluorophosphate ion), and a hydroxide ion. X is preferably a halogen anion, a sulfonate ion, or a hydroxide ion. In addition, a chlorine ion, a bromine ion, an iodine ion, a methanesulfonate ion, a vinylsulfonate ion, a p-toluenesulfonate ion, or a p-vinylbenzenesulfonate ion is particularly preferable.

L¹ represents a divalent linking group. Examples of L¹ include a divalent linking group having 1 to 20 carbon atoms, consisting of a combination of an alkylene group, —O—, —S—, —CO—, —SO₂—, —NRa— (here, Ra is an alkyl group having 1 to 5 carbon atoms or a hydrogen atom), an alkenylene group, an alkynylene group, and an arylene group. L¹ is preferably -AL-, —O-AL-, —CO—O-AL-, or —O—CO-AL-, each of which has 1 to 10 carbon atoms, more preferably -AL- or —O-AL-, each of which has 1 to 10 carbon atoms, and most preferably -AL-, or —O-AL-, each of which has 1 to 5 carbon atoms. AL represents an alkylene group.

L² represents a single bond or a divalent linking group. Examples of L² include a divalent linking group having 1 to 10 carbon atoms, consisting of a combination of an alkylene group, —O—, —S—, —CO—, —SO₂—, —NRa— (here, Ra is an alkyl group having 1 to 5 carbon atoms or a hydrogen atom), an alkenylene group, an alkynylene group, and an arylene group; a single bond, —O—, —O—CO—, —CO—O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, and —O—CO-AL-CO—O—. AL represents an alkylene group. L² is preferably a single bond, -AL-, —O-AL-, or —NRa-AL-O—, each of which has 1 to 10 carbon atoms, more preferably a single bond, -AL-, —O-AL-, or —NRa-AL-O—, each of which has 1 to 5 carbon atoms, and most preferably a single bond, —O-AL-, or —NRa-AL-O—, each of which has 1 to 5 carbon atoms.

Y¹ represents a divalent linking group having a 5-membered ring or a 6-membered ring as a partial structure. Examples of Y¹ include a cyclohexyl ring, an aromatic ring, or a heterocyclic ring. Examples of the aromatic ring include a benzene ring, an indene ring, a naphthalene ring, a fluorene ring, a phenanthrene ring, an anthracene ring, a biphenyl ring, and a pyrene ring, and a benzene ring, a biphenyl ring, or a naphthalene ring is particularly preferable. As a heteroatom constituting the heterocyclic ring, a nitrogen atom, an oxygen atom, or a sulfur atom is preferable, and examples of the heterocyclic ring include a furan ring, a thiophene ring, a pyrrole ring, a pyrroline ring, a pyrrolidine ring, an oxazole ring, an isoxazole ring, a thiazole ring, an isothiazole ring, an imidazole ring, an imidazoline ring, an imidazolidine ring, a pyrazole ring, a pyrazoline ring, a pyrazolidine ring, a triazole ring, a furazan ring, a tetrazole ring, a pyran ring, a dioxane ring, a dithiane ring, a thiin ring, a pyridine ring, a piperidine ring, an oxazine ring, a morpholine ring, a thiazine ring, a pyridazine ring, a pyrimidine ring, a pyrazine ring, a piperazine ring, and a triazine ring. The heterocyclic ring is preferably a 6-membered ring. The divalent linking group represented by Y¹, having a 5-membered ring or 6-membered ring as a partial structure, may further have a substituent (for example, the above-described substituent W).

The divalent linking group represented by Y¹ is preferably a divalent linking group having two or more 5-membered ring or 6-membered rings, and more preferably has a structure in which two or more rings are linked to each other through a linking group.

Examples of the linking group include the examples of the linking group represented by L¹ and L², —C≡C—, —CH═CH—, —CH═N—, —N═CH—, and —N═N—.

Z represents a divalent linking group which has an alkylene group having 2 to 20 carbon atoms as a partial structure and consists of a combination of —O—, —S—, —CO—, and —SO₂—, in which the alkylene group may have a substituent. Examples of the above-described divalent linking group include an alkyleneoxy group and a polyalkyleneoxy group. The number of carbon atoms in the alkylene group represented by Z is more preferably 2 to 16, still more preferably 2 to 12, and particularly preferably 2 to 8.

P¹ and P² each independently represent a monovalent substituent having a polymerizable ethylenically unsaturated group. Examples of the above-described monovalent substituent having a polymerizable ethylenically unsaturated group include Formulae (M-1) to (M-8). That is, the monovalent substituent having a polymerizable ethylenically unsaturated group may be a substituent consisting of only an ethenyl group as in Formula (M-8).

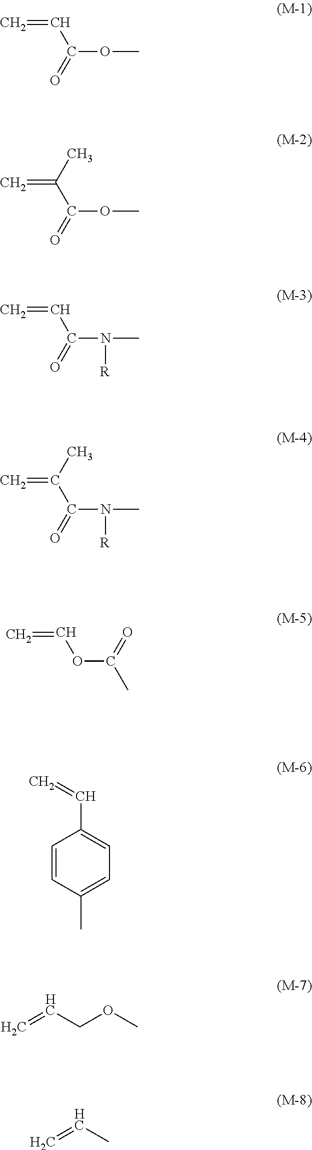

In Formulae (M-3) and (M-4), R represents a hydrogen atom or an alkyl group, and a hydrogen atom or a methyl group is preferable. Among Formulae (M-1) to (M-8), (M-1), (M-2), or (M-8) is preferable, and (M-1) or (M-8) is more preferable. In particular, P¹ is preferably (M-1). In addition, P² is preferably (M-1) or (M-8), and in a compound in which the ring A is quaternary imidazolium ion, P² is preferably (M-8) or (M-1), and in a compound in which the ring A is a quaternary pyridinium ion, P² is preferably (M-1).

Examples of the onium compound represented by Formula (B1) include onium salts described in paragraphs 0052 to 0058 of JP2012-208397A, onium salts described in paragraphs 0024 to 0055 of JP2008-026730A, and onium salts described in JP2002-37777A.

In the present invention, from the reason that the alignment degree of the formed light absorption anisotropic layer is increased, it is preferable that the above-described alignment agent is a boronic acid compound represented by Formula (B2).

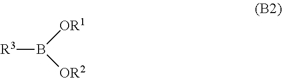

In (B2), R¹ and R² each independently represent a hydrogen atom, an aliphatic hydrocarbon group which may have a substituent, an aryl group which may have a substituent, or a heterocyclic group which may have a substituent.

In addition, R³ represents a substituent.

Examples of the aliphatic hydrocarbon group represented by one aspect of R¹ and R² include a linear or branched alkyl group having 1 to 20 carbon atoms, which may be substituted or unsubstituted, (for example, a methyl group, an ethyl group, an iso-propyl group, and the like), a substituted or unsubstituted cyclic alkyl group having 3 to 20 carbon atoms (for example, a cyclohexyl group and the like), and an alkenyl group having 2 to 20 carbon atoms (for example, a vinyl group and the like).

In addition, examples of the aryl group represented by one aspect of R¹ and R² include a substituted or unsubstituted phenyl group having 6 to 20 carbon atoms (for example, a phenyl group, a tolyl group, and the like), and a substituted or unsubstituted naphthyl group having 10 to 20 carbon atoms.

In addition, examples of the heterocyclic group represented by one aspect of R¹ and R² include a substituted or unsubstituted 5-membered or 6-membered ring group including at least one heteroatom (for example, a nitrogen atom, an oxygen atom, a sulfur atom, and the like), and specific examples thereof include a pyridyl group, an imidazolyl group, a furyl group, a piperidyl group, and a morpholino group.

R¹ and R² may be linked to each other to form a ring. For example, isopropyl groups of R¹ and R² may be linked to each other to form a 4,4,5,5-tetramethyl-1,3,2-dioxaborolane ring.

As R¹ and R², a hydrogen atom, a linear or branched alkyl group having 1 to 3 carbon atoms, or an aspect in which these groups are linked to each other to form a ring is preferable, and a hydrogen atom is more preferable.

As the substituent represented by R³, a substituent including a functional group which can be bonded to a (meth)acrylic group is preferable.

Here, examples of the functional group which can be bonded to a (meth)acrylic group include a vinyl group, an acrylate group, a methacrylate group, an acrylamide group, a styryl group, a vinyl ketone group, a butadiene group, a vinyl ether group, an oxiranyl group, an aziridinyl group, and an oxetane group. Among these, a vinyl group, an acrylate group, a methacrylate group, a styryl group, an oxiranyl group, or an oxetane group is preferable, and a vinyl group, an acrylate group, an acrylamide group, or a styryl group is more preferable.

R³ is preferably a substituted or unsubstituted aliphatic hydrocarbon group, aryl group, or heterocyclic group having the functional group which can be bonded to a (meth)acrylic group.

Examples of the aliphatic hydrocarbon group include a substituted or unsubstituted linear or branched alkyl group having 1 to 30 carbon atoms (for example, a methyl group, an ethyl group, an iso-propyl group, an n-propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eicosyl group, an isopropyl group, an isobutyl group, an sec-butyl group, a tert-butyl group, an isopentyl group, a neopentyl group, a 1-methylbutyl group, an isohexyl group, a 2-methylhexyl group, and the like), a substituted or unsubstituted cyclic alkyl group having 3 to 20 carbon atoms (for example, a cyclopentyl group, a cyclohexyl group, a 1-adamantyl group, a 2-norbornyl group, and the like), and an alkenyl group having 2 to 20 carbon atoms (for example, a vinyl group, a 1-propenyl group, a 1-butenyl group, a 1-methyl-1-propenyl group, and the like).

Examples of the aryl group include a substituted or unsubstituted phenyl group having 6 to 50 carbon atoms (for example, a phenyl group, a tolyl group, a styryl group, a 4-benzoyloxyphenyl group, a 4-phenoxycarbonylphenyl group, a 4-biphenyl group, a 4-(4-octyloxybenzoyloxy)phenoxycarbonylphenyl group, and the like), and a substituted or unsubstituted naphthyl group having 10 to 50 carbon atoms (for example, an unsubstituted naphthyl group and the like).

The heterocyclic group is, for example, a substituted or unsubstituted 5-membered or 6-membered ring group including at least one heteroatom (for example, a nitrogen atom, an oxygen atom, a sulfur atom, and the like), and examples thereof include groups of pyrrole, furan, thiophene, pyrazole, imidazole, triazole, oxazole, isoxazole, oxadiazole, thiazole, thiadiazole, indole, carbazole, benzofuran, dibenzofuran, thianaphthene, dibenzothiophene, indazole, benzimidazole, anthranil, benzisoxazole, benzoxazole, benzothiazole, purine, pyridine, pyridazine, pyrimidine, pyrazine, triazine, quinoline, acridine, isoquinoline, phthalazine, quinazoline, quinoxaline, naphthyridine, phenanthroline, pteridine, morpholine, and piperidine, and the like.

Examples of the boronic acid compound represented by Formula (B2) include a boronic acid compound represented by General Formula (I) described in paragraphs 0023 to 0032 of JP2008-225281A.

As the compound represented by Formula (B2), compounds exemplified below are also preferable.

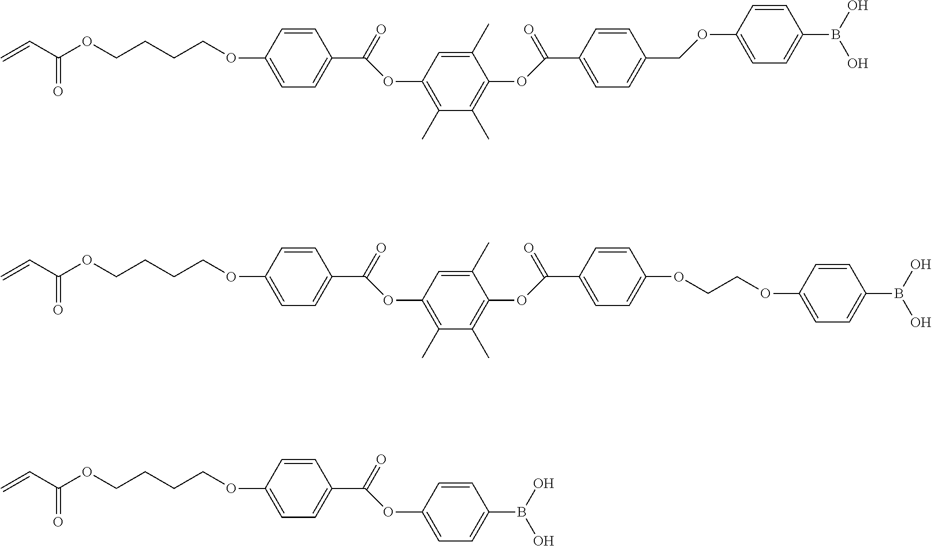 [SMILES: C=CC(=O)OCCCCOc1ccc(C(=O)Oc2cc(C)c(OC(=O)c3ccc(COc4ccc(B(O)O)cc4)cc3)c(C)c2C)cc1 ; C=CC(=O)OCCCCOc1ccc(C(=O)Oc2cc(C)c(OC(=O)c3ccc(OCCOc4ccc(B(O)O)cc4)cc3)c(C)c2C)cc1 ; C=CC(=O)OCCCCOc1ccc(C(=O)Oc2ccc(B(O)O)cc2)cc1]

In a case where the liquid crystal composition according to the present invention contains an alignment agent, a content of the alignment agent is preferably 0.2 to 20 parts by mass and more preferably 1 to 10 parts by mass with respect to the total of 100 parts by mass of the liquid crystal compound and the dichroic substance contained in the liquid crystal composition.

### [Other Components]

The liquid crystal composition of the embodiment of the present invention may include components other than the above-mentioned components. Examples of the other components include an adhesion improver and a plasticizer.

### [Light Absorption Anisotropic Film]

The light absorption anisotropic film according to the embodiment of the present invention is a light absorption anisotropic film formed of the liquid crystal composition according to the embodiment of the present invention, and is preferably a light absorption anisotropic film obtained by immobilizing the alignment state of the liquid crystal composition according to the embodiment of the present invention. The alignment state of the liquid crystal composition (particularly, the liquid crystal compound) may be any of a horizontal alignment state, a vertical alignment state, an inclined alignment state, or a twisted alignment state.

The light absorption anisotropic film according to the embodiment of the present invention is preferably a light absorption anisotropic film obtained by immobilizing the liquid crystal compound contained in the liquid crystal composition according to the embodiment of the present invention in a horizontally aligned state.

Here, the “horizontal alignment” means that the main surface of the light absorption anisotropic film (or, in a case where the light absorption anisotropic film is formed on a member such as a support and an alignment film, a surface of the member) is parallel to the major axis direction of the liquid crystal compound. Incidentally, it is not required for the both to be strictly parallel, and in the present specification, the expression means that the both are aligned at an angle formed by the major axis direction of the liquid crystal compound and the main surface of the light absorption anisotropic film of less than 10°.

In the light absorption anisotropic film, the angle between the major axis direction of the liquid crystal compound and the main surface of the light absorption anisotropic film is preferably 0° to 5°, more preferably 0° to 3°, and still more preferably 0° to 2°.

The light absorption anisotropic film according to the embodiment of the present invention is preferably a light absorption anisotropic film obtained by immobilizing the liquid crystal compound contained in the liquid crystal composition according to the embodiment of the present invention in a vertically aligned state.

That is, in the light absorption anisotropic film according to the embodiment of the present invention, the angle θ between the transmittance central axis of the light absorption anisotropic film and the normal direction of the surface of the light absorption anisotropic film is preferably 0° or more and 450 or less, more preferably 0° or more and less than 45°, still more preferably 0° or more and 350 or less, and particularly preferably 0° or more and less than 35°.

Here, the transmittance central axis of the light absorption anisotropic film means a direction in which the highest transmittance is exhibited in a case where the transmittance is measured by changing the inclination angle (polar angle) and the inclination direction (azimuthal angle) with respect to the normal direction of the surface of the light absorption anisotropic film.

Specifically, the Mueller matrix at a wavelength of 550 nm is measured using AxoScan (OPMF-2, manufactured by Axometrics, Inc.). More specifically, in the measurement, the azimuthal angle at which the transmittance central axis is inclined is first searched for, the Mueller matrix at a wavelength of 550 nm is measured while the polar angle which is the angle with respect to the surface of the light absorption anisotropic film in the normal direction is changed from −70° to 700 at intervals of 10 in the surface (the plane which has the transmittance central axis and is orthogonal to the film surface) having the normal direction of the light absorption anisotropic film along the azimuthal angle thereof, and the transmittance of the light absorption anisotropic film is derived. As a result, the direction in which the highest transmittance is exhibited is defined as the transmittance central axis.

The transmittance central axis denotes a direction of an absorption axis (major axis direction of a molecule) of the dichroic substance contained in the light absorption anisotropic film.

From the reason that the alignment degree is further increased, the thickness of the light absorption anisotropic film according to the embodiment of the present invention is preferably 1.5 μm or more, more preferably 2 to 10 μm, and still more preferably 2 to 8 μm.

Here, the thickness of the light absorption anisotropic film is measured by cutting the light absorption anisotropic layer using a microtome to prepare a sample having a cross section, observing the cross section with a scanning electron microscope from a normal direction with respect to the cross section, and measuring the thickness.

### [Manufacturing Method of Light Absorption Anisotropic Film]

Suitable examples of the method of producing a light absorption anisotropic film according to the embodiment of the present invention include a method comprising: a coating film forming step of applying the liquid crystal composition according to the embodiment of the present invention to form a coating film; a cleavage step of generating an acid in the coating film by light irradiation or heating after the coating film forming step, and cleaving an acid-cleavable group of the dichroic substance represented by Formula (1) (X in Formula (1)); an alignment step of aligning the dichroic substance having the cleaved acid-cleavable group after the cleavage step; and a curing step of immobilizing an alignment state of the dichroic substance after the alignment step to obtain the light absorption anisotropic film.

Hereinafter, each step of the method of producing a light absorption anisotropic film according to the embodiment of the present invention will be described.

### [Coating Film Forming Step]

The coating film forming step is a step of applying the liquid crystal composition according to the embodiment of the present invention to form a coating film.

The liquid crystal composition is easily coated by using the liquid crystal composition containing the above-described solvent or using a liquid such as a melt obtained by heating the liquid crystal composition.

Examples of the method of coating the base material with the liquid crystal composition include known methods such as a roll coating method, a gravure printing method, a spin coating method, a wire bar coating method, an extrusion coating method, a direct gravure coating method, a reverse gravure coating method, a die coating method, a spraying method, and an ink jet method.

### [Cracking Step]

The cleavage step is a step of generating an acid in the coating film by light irradiation or heating, and cleaving an acid-cleavable group of the dichroic substance represented by Formula (1) (X in Formula (1)).

Here, a method of generating an acid in the coating film is not particularly limited, and examples thereof include a method of adding an acid to the coating film; and a method of forming a coating film using a liquid crystal composition containing an acid generator and heating or irradiating the coating film with light to generate an acid.

In addition, as the acid, an acid having a pKa of 3 or less is preferable, and specifically, a sulfonic acid or a phosphonic acid is preferable, and a sulfonic acid is more preferable.

In addition, in a case where a coating film is formed using a liquid crystal composition containing a thermal acid generator, a temperature at which the coating film is heated is not particularly limited because it varies depending on the type of the thermal acid generator, but is preferably 40° C. to 300° C., more preferably 80° C. to 260° C., still more preferably 100° C. to 220° C., and particularly preferably 120° C. to 200° C.

In addition, in a case where a coating film is formed using a liquid crystal composition containing a photoacid generator, conditions for irradiating the coating film with light are not particularly limited, and examples thereof include a method of irradiating the coating film with ultraviolet rays. As a light source, a lamp emitting ultraviolet rays, such as a high-pressure mercury lamp and a metal halide lamp, can be used. In addition, the irradiation dose is preferably 10 mJ/cm² to 50 J/cm², more preferably 20 mJ/cm² to 5 J/cm², even more preferably 30 mJ/cm² to 3 J/cm², and particularly preferably 50 to 1,000 mJ/cm².

### [Alignment Step]

The alignment step is a step of aligning the dichroic substance (after cleavage of the acid-cleavable group in a case of having the acid-cleavable group) contained in the coating film.

The alignment step may include a drying treatment. Components such as a solvent can be removed from the coating film by performing the drying treatment. The drying treatment may be performed according to a method of allowing the coating film to stand at room temperature for a predetermined time (for example, natural drying) or a method of heating the coating film and/or blowing air to the coating film.

Here, the dichroic substance contained in the liquid crystal composition may be aligned by performing the above-described coating film forming step or drying treatment. For example, in an aspect in which the liquid crystal composition is prepared as a coating solution containing a solvent, a coating film having light absorption anisotropy (that is, an uncured light absorption anisotropic film) is obtained by drying the coating film and removing the solvent from the coating film.

It is preferable that the alignment step includes a heat treatment. In this manner, since the dichroic substance contained in the coating film can be aligned, the coating film after being subjected to the heat treatment can be suitably used as the light absorption anisotropic film.

From the viewpoint of the manufacturing suitability, the heat treatment is performed at a temperature of preferably 10° C. to 250° C. and more preferably 25° C. to 190° C. Further, the heating time is preferably in a range of 1 to 300 seconds and more preferably in a range of 1 to 60 seconds.

The alignment step may include a cooling treatment performed after the heat treatment. The cooling treatment is a treatment of cooling the coating film after being heated to room temperature (20° C. to 25° C.). In this manner, the alignment of the dichroic substance contained in the coating film can be fixed. The cooling means is not particularly limited and can be performed according to a known method.

The light absorption anisotropic film can be obtained by performing the above-described steps.

In the present aspect, examples of the method of aligning the dichroic substance contained in the coating film include a drying treatment and a heat treatment, but the method is not limited thereto, and the dichroic substance can be aligned by a known alignment treatment.

### [Curing Step]

The curing step is a step of immobilizing the alignment state of the dichroic substance after the alignment step, thereby obtaining a light absorption anisotropic film.

The curing step is performed by, for example, heating the film and/or irradiating (exposing) the film with light. Between these, it is preferable that the curing step is performed by irradiating the film with light.

Various light sources such as infrared rays, visible light, and ultraviolet rays can be used as the light source for curing, but ultraviolet rays are preferable. In addition, in the curing, ultraviolet rays may be applied while heating is performed. Otherwise, ultraviolet rays may be applied via a filter which transmits only a component with a specific wavelength.

In addition, the exposure may be performed under a nitrogen atmosphere. In a case where the curing of the light absorption anisotropic film proceeds by radical polymerization, since the inhibition of polymerization by oxygen is reduced, it is preferable that exposure is performed in a nitrogen atmosphere.

### [Optical Laminate]

The optical laminate according to the embodiment of the present invention has the light absorption anisotropic film according to the embodiment of the present invention.

In addition, the optical laminate according to the embodiment of the present invention may have a substrate that supports the light absorption anisotropic film according to the embodiment of the present invention.

The optical laminate according to the embodiment of the present invention may further have a λ/4 plate formed on the light absorption anisotropic film.

In addition, the optical laminate according to the embodiment of the present invention may have an alignment film between the substrate and the light absorption anisotropic film.

In addition, the optical laminate according to the embodiment of the present invention may have a barrier layer between the light absorption anisotropic film and the λ/4 plate.

Hereinafter, the respective layers forming the optical laminate according to the embodiment of the present invention will be described.

### [Base Material]

The base material can be appropriately selected depending on the applications of the light absorption anisotropic film, and examples thereof include glass and a polymer film. The light transmittance of the base material is preferably 80% or greater.

In a case where a polymer film is used as the base material, it is preferable to use an optically isotropic polymer film. As specific examples and preferred aspects of the polymer, the description in paragraph [0013] of JP2002-22942A can be applied. Further, even in a case of a polymer easily exhibiting the birefringence such as polycarbonate and polysulfone which has been known in the related art, a polymer with the exhibiting property which has been decreased by modifying the molecules described in WO2000/26705A can be used.

### [Light Absorption Anisotropic Film]

The light absorption anisotropic film is as described above, and thus the description thereof will not be repeated.

[λ/4 plate]

a “λ/4 Plate” is a Plate Having a λ/4 Function, Specifically, a Plate Having a Function of converting linearly polarized light having a specific wavelength into circularly polarized light (or converting circularly polarized light into linearly polarized light).

For example, specific examples of an aspect in which a λ/4 plate has a single-layer structure include a stretched polymer film and a phase difference film in which an optically anisotropic layer having a λ/4 function is provided on a support. Further, specific examples of a form in which a λ/4 plate has a multilayer structure include a broadband λ/4 plate obtained by laminating a λ/4 plate and a V/2 plate.

The λ/4 plate and the light absorption anisotropic film may be provided by coming into contact with each other, or another layer may be provided between the λ/4 plate and the light absorption anisotropic film. Examples of such a layer include a pressure sensitive adhesive layer or an adhesive layer for ensuring the adhesiveness, and a barrier layer.

### [Barrier Layer]

In a case where the optical laminate according to the embodiment of the present invention has a barrier layer, the barrier layer is provided between the light absorption anisotropic film and the λ/4 plate. In a case where a layer other than the barrier layer (for example, a pressure-sensitive adhesive layer or an adhesive layer) is provided between the light absorption anisotropic film and the λ/4 plate, the barrier layer can be provided between, for example, the light absorption anisotropic film and the above layer other than the barrier layer.

The barrier layer is also called a gas barrier layer (an oxygen barrier layer) and has the function of protecting a light absorption anisotropic film from a gas such as oxygen in the atmosphere, moisture, or a compound contained in the adjacent layer.

The barrier layer can refer to, for example, the description in paragraphs [0014] to [0054] of JP2014-159124A, paragraphs [0042] to [0075] of JP2017-121721A, paragraphs [0045] to [0054] of JP2017-115076A, paragraphs [0010] to [0061] of JP2012-213938A, and paragraphs [0021] to [0031] of JP2005-169994A.

### [Alignment Film]

The optical laminate according to the embodiment of the present invention may include an alignment film between the base material and the light absorption anisotropic film.

The alignment film may be any layer as long as the dichroic substance contained in the liquid crystal composition according to the embodiment of the present invention can be in a desired alignment state on the alignment film.

An alignment layer can be provided by means such as a rubbing treatment performed on a film surface of an organic compound (preferably a polymer), oblique vapor deposition of an inorganic compound, formation of a layer having microgrooves, or accumulation of an organic compound (such as ω-tricosanoic acid, dioctadecylmethylammonium chloride, or methyl stearylate) according to a Langmuir-Blodgett method (LB film). Further, an alignment film in which an alignment function is generated by application of an electric field, application of a magnetic field, or irradiation with light is also known. Among these, in the present invention, an alignment film formed by performing a rubbing treatment is preferable from the viewpoint of easily controlling the pretilt angle of the alignment film, and a photo-alignment film formed by irradiation with light is also preferable from the viewpoint of the uniformity of alignment.

### <Rubbing Treatment Alignment Film>

A polymer material used for the alignment film formed by performing a rubbing treatment is described in multiple documents, and a plurality of commercially available products can be used. In the present invention, polyvinyl alcohol or polyimide and derivatives thereof are preferably used. The alignment film can refer to the description on page 43, line 24 to page 49, line 8 of WO2001/88574A1. A thickness of the alignment film is preferably 0.01 to 10 m and more preferably 0.01 to 1 m.

### <Photo-Alignment Film>

A photo-alignment material used for an alignment film formed by irradiation with light is described in a plurality of documents. In the present invention, preferred examples thereof include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B, aromatic ester compounds described in JP2002-229039A, maleimide and/or alkenyl-substituted nadiimide compounds having a photo-alignment unit described in JP2002-265541A and JP2002-317013A, photocrosslinkable silane derivatives described in JP4205195B and JP4205198B, photocrosslinkable polyimides, polyamides, or esters described in JP2003-520878A, JP2004-529220A, and JP4162850B. Among these, azo compounds, photocrosslinkable polyimides, polyamides, or esters are more preferable.

The photo-alignment film formed of the above-described material is irradiated with linearly polarized light or non-polarized light to produce a photo-alignment film.

In the present specification, the “irradiation with linearly polarized light” and the “irradiation with non-polarized light” are operations for causing a photoreaction in the photo-alignment material. The wavelength of the light to be used varies depending on the photo-alignment material to be used and is not particularly limited as long as the wavelength is required for the photoreaction. The peak wavelength of light to be used for irradiation with light is preferably in a range of 200 nm to 700 nm, and ultraviolet light having a peak wavelength of 400 nm or less is more preferable.

Examples of the light source used for irradiation with light include commonly used light sources, for example, lamps such as a tungsten lamp, a halogen lamp, a xenon lamp, a xenon flash lamp, a mercury lamp, a mercury xenon lamp, or a carbon arc lamp, various lasers [such as a semiconductor laser, a helium neon laser, an argon ion laser, a helium cadmium laser, and a yttrium aluminum garnet (YAG) laser], a light emitting diode, and a cathode ray tube.

As a method of obtaining the linearly polarized light, a method of using a polarizing plate (for example, iodine polarizing plate, dichroic coloring agent polarizing plate, and wire grid polarizing plate), a method of using a prismatic element (for example, Glan-Thomson prism) or a reflective type polarizer using Brewster's angle, or a method of using light emitted from a polarized laser light source can be adopted. Further, only light having a required wavelength may be selectively applied using a filter, a wavelength conversion element, or the like.

In a case where light to be applied is linearly polarized light, a method of applying light vertically or obliquely to the upper surface with respect to the alignment film or the surface of the alignment film from the rear surface is employed. The incident angle of light varies depending on the photo-alignment material, but is preferably 0° to 90° (orthogonal), and more preferably 40° to 90°.

In a case where light to be applied is non-polarized light, the alignment film is irradiated with non-polarized light obliquely. An incidence angle is preferably 10° to 80°, more preferably 20θ to 60°, and particularly preferably 30θ to 50°.

The irradiation time is preferably in a range of 1 minute to 60 minutes and more preferably in a range of 1 minute to 10 minutes.

In a case where patterning is required, a method of performing irradiation with light using a photomask as many times as necessary for pattern preparation or a method of writing a pattern by laser light scanning can be employed.

### [Applications]

The optical laminate according to the embodiment of the present invention can be used as a polarizing element (polarizing plate) or the like, for example, as a linearly polarizing plate or a circularly polarizing plate.

In a case where the laminate of the present invention does not include an optically anisotropic layer such as the λ/4 plate, the laminate can be used as a linearly polarizing plate.

Meanwhile, in a case where the laminate of the present invention includes the λ/4 plate, the laminate can be used as a circularly polarizing plate.

### [0108][Image Display Device]

An image display device according to the embodiment of the present invention includes the above-described light absorption anisotropic film or the above-described laminate.

The display element used in the image display device according to the embodiment of the present invention is not particularly limited, and examples thereof include a liquid crystal cell, an organic electroluminescence (hereinafter, abbreviated as “EL”) display panel, and a plasma display panel.

Among these, a liquid crystal cell or an organic EL display panel is preferable, and a liquid crystal cell is more preferable. That is, in the image display device of the present invention, a liquid crystal display device formed of a liquid crystal cell as a display element or an organic EL display device formed of an organic EL display panel as a display element is preferable, and a liquid crystal display device is more preferable.

### [Liquid Crystal Display Device]

As a liquid crystal display device which is an example of the image display device according to the embodiment of the present invention, an aspect of a liquid crystal display device including the above-described light absorption anisotropic film and a liquid crystal cell is preferably exemplified. A liquid crystal display device including the above-described laminate (here, the laminate does not include a λ/4 plate) and a liquid crystal cell is more suitable.

In the present invention, between the light absorption anisotropic films (laminate) provided on both sides of the liquid crystal cell, it is preferable that the light absorption anisotropic film (laminate) according to the embodiment of the present invention is used as a front-side polarizing element and more preferable that the light absorption anisotropic film (laminate) according to the embodiment of the present invention is used as a front-side polarizing element and a rear-side polarizing element.

Hereinafter, the liquid crystal cell constituting the liquid crystal display device will be described in detail.

### <Liquid Crystal Cell>

It is preferable that the liquid crystal cell used for the liquid crystal display device is in a vertical alignment (VA) mode, an optically compensated bend (OCB) mode, an in-plane-switching (IPS) mode, or a twisted nematic (TN) mode, but the present invention is not limited thereto.

In the liquid crystal cell in a TN mode, rod-like liquid crystalline molecules are substantially horizontally aligned at the time of no voltage application and further twisted aligned at 600 to 120°. The liquid crystal cell in a TN mode is most likely used as a color thin film transistor (TFT) liquid crystal display device and is described in multiple documents.

In the liquid crystal cell in a VA mode, rod-like liquid crystalline molecules are substantially vertically aligned at the time of no voltage application. The concept of the liquid crystal cell in a VA mode includes (1) a liquid crystal cell in a VA mode in a narrow sense where rod-like liquid crystalline molecules are aligned substantially vertically at the time of no voltage application and substantially horizontally at the time of voltage application (described in JP1990-176625A (JP-H2-176625A)), (2) a liquid crystal cell (in an MVA mode) (SID97, described in Digest of tech. Papers (proceedings) 28 (1997) 845) in which the VA mode is formed to have multi-domain in order to expand the viewing angle, (3) a liquid crystal cell in a mode (n-ASM mode) in which rod-like liquid crystal molecules are substantially vertically aligned at the time of no voltage application and twistedly multi-domain aligned at the time of voltage application (described in proceedings of Japanese Liquid Crystal Conference, p. 58 to 59 (1998)), and (4) a liquid crystal cell in a SURVIVAL mode (presented at LCD International 98). Further, the liquid crystal cell may be of any of a patterned vertical alignment (PVA) type, a photo-alignment (optical alignment) type, or a polymer-sustained alignment (PSA) type. Details of these modes are described in JP2006-215326A and JP2008-538819A.

In the liquid crystal cell in an IPS mode, rod-like liquid crystal molecules are aligned substantially parallel to the substrate, and the liquid crystal molecules respond planarly through application of an electric field parallel to the substrate surface. In the IPS mode, black display is carried out in a state where no electric field is applied, and absorption axes of a pair of upper and lower polarizing plates are orthogonal to each other. A method of reducing light leakage during black display in an oblique direction and improve the viewing angle using an optical compensation sheet is disclosed in JP1998-54982A (JP-H10-54982A), JP1999-202323A (JP-H11-202323A), JP1997-292522A (JP-H9-292522A), JP1999-133408A (JP-H11-133408A), JP1999-305217A (JP-H11-305217A), and JP1998-307291A (JP-H10-307291A).

### [Organic EL Display Device]

As an organic EL display device which is an example of the image display device according to the embodiment of the present invention, an aspect of an image display device including a light absorption anisotropic film, a λ/4 plate, and an organic EL display panel in this order from the viewing side is suitably exemplified.

An aspect of an image display device including the above-described laminate including a λ/4 plate and an organic EL display panel in this order from the viewing side is more suitably exemplified. In this case, the laminate is formed such that a base material, an alignment film provided as necessary, a light absorption anisotropic film, a barrier layer provided as necessary, and a λ/4 plate are disposed in this order from the viewing side.

Further, the organic EL display panel is a display panel formed using an organic EL element having an organic light-emitting layer (organic electroluminescence layer) interposed between electrodes (between a cathode and an anode). The configuration of the organic EL display panel is not particularly limited, and a known configuration is employed.

### EXAMPLES

Hereinbelow, the present invention will be described in more detail with reference to Examples. The materials, the amounts of materials used, the ratios, the treatment details, the treatment procedure, or the like shown in the following Examples can be appropriately modified without departing from the spirit of the present invention. Therefore, the scope of the present invention should not be limitatively interpreted by the following examples.

### Synthesis Example

### [Synthesis of Dichroic Substance B-1]

The dichroic substance B-1 represented by Formula B-1 was synthesized according to the following scheme.

In the following scheme, Ac represents an acetyl group.

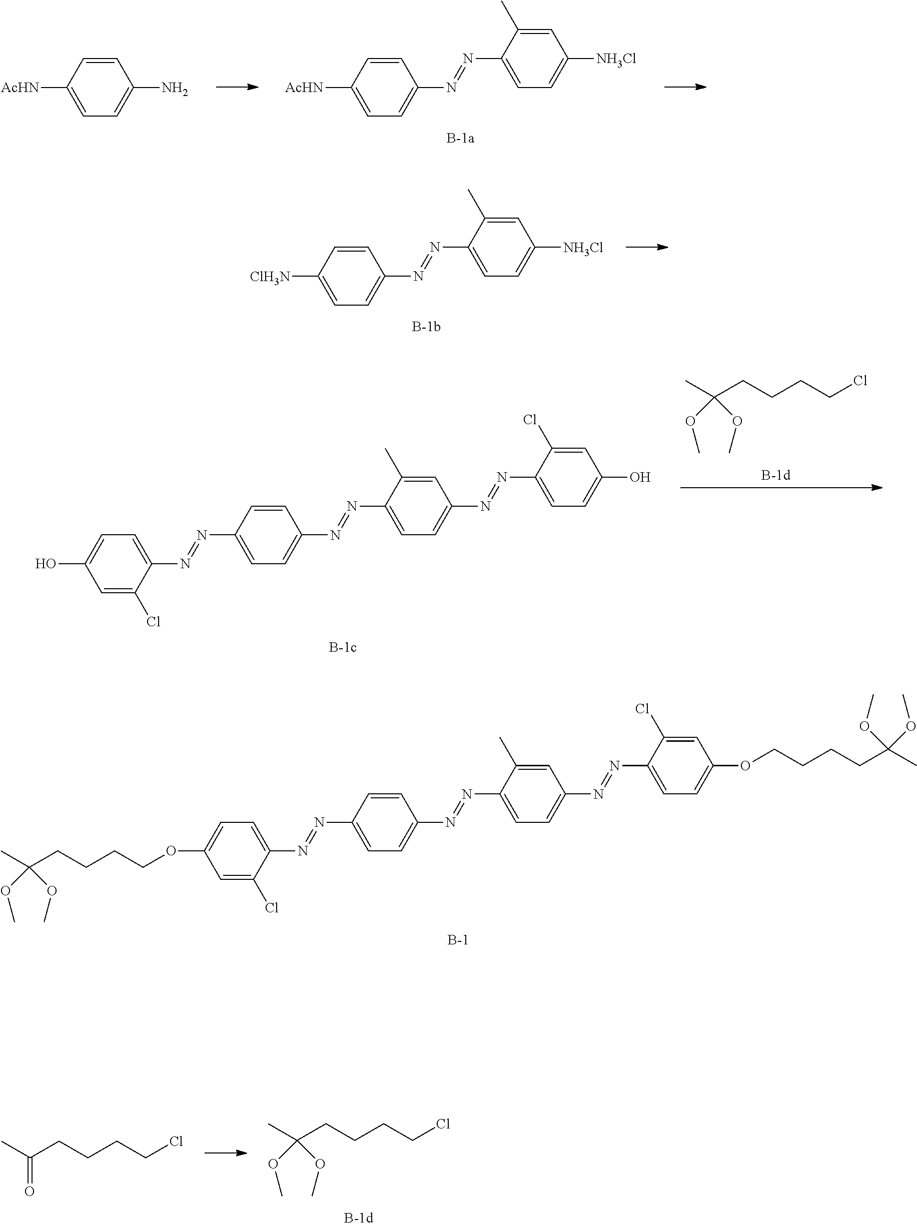

Specifically, p-acetanilide (10 g) was dissolved in water (300 mL) and 12 mol/L (liter) hydrochloric acid (17 mL), cooled in an ice bath, and sodium nitrite (3.3 g) was added thereto and stirred for 30 minutes. Further, m-toluidine (5.1 g) was added thereto after addition of amidosulfuric acid (0.5 g), and the solution was stirred at room temperature for 1 hour. After stirring, the mixture was neutralized with hydrochloric acid, and the obtained solid was collected by suction filtration to obtain a compound B-1a (6.4 g) represented by Formula B-1a.

Next, the compound B-1a (6.4 g) was dissolved in methanol (50 mL), water (20 mL), and hydrochloric acid (10 mL), heated at 80° C. for 8 hours, cooled to room temperature, and the obtained solid was collected by suction filtration to obtain a compound B-1b (4.0 g) represented by Formula B-1b.

Next, the compound B-1b (3.5 g) was dissolved in water (35 mL) and hydrochloric acid (2.0 mL), cooled in an ice bath, and sodium nitrite (1.9 g) was added thereto and stirred for 120 minutes. Furthermore, after adding amide sulfate (0.5 g), a solution obtained by mixing m-chlorophenol (4.5 g), 48% potassium hydroxide aqueous solution (4.0 g), and water (24 mL) was added thereto and the mixture was stirred at room temperature for 1 hour. After stirring, the mixture was neutralized with hydrochloric acid, and the obtained solid was collected by suction filtration to obtain a compound B-1c (4.0 g) represented by Formula B-1c.

Separately, methanol (100 mL) and (+)-camphorsulfonic acid (0.1 g) were added to 6-chloro-2-hexanone (25 g), and trimethyl orthoformate (20 g) was added dropwise thereto over 10 minutes while maintaining the temperature in a water bath, and the mixture was stirred for 30 minutes. Saturated sodium hydrogen carbonate aqueous solution (10 mL) was added to stop the reaction, hexane (200 mL) and water (200 mL) were added thereto, and the mixture was subjected to a separation operation. The obtained organic layer was dried with magnesium sulfate, filtered, and the filtrate was concentrated to obtain a compound B-1d (28 g) represented by Formula B-1d.

Next, the compound B-1c (4.0 g), the compound B-1d (2.0 g), potassium carbonate (1.5 g), and potassium iodide (0.4 g) were dissolved in N,N-dimethylacetamide (DMAc) (50 mL), and the mixture was stirred at 85° C. for 8 hours. After stirring, hydrochloric acid (1.0 g), water (10 mL), and methanol (50 mL) were added thereto, and the obtained solid was collected by suction filtration to obtain a dichroic substance B-1 (4.5 g).

### [Synthesis of Dichroic Substance B-2]

The dichroic substance B-2 represented by Formula B-2 was synthesized according to the following scheme.

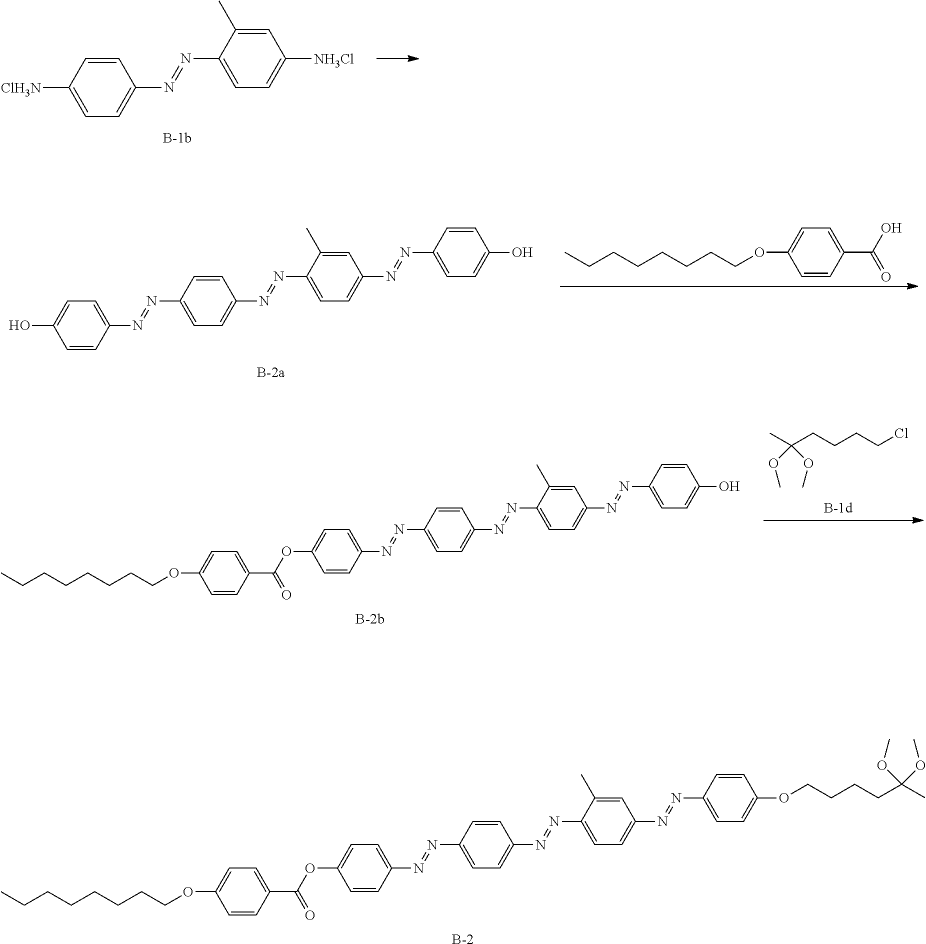

Specifically, the compound B-1b (3.5 g) was dissolved in water (35 mL) and hydrochloric acid (2.0 mL), cooled in an ice bath, and sodium nitrite (1.9 g) was added thereto and stirred for 120 minutes. Furthermore, after adding amide sulfate (0.5 g), a solution obtained by mixing phenol (3.5 g), 48% potassium hydroxide aqueous solution (4.0 g), and water (24 mL) was added thereto and the mixture was stirred at room temperature for 1 hour. After stirring, the mixture was neutralized with hydrochloric acid, and the obtained solid was collected by suction filtration to obtain a compound B-2a (3.6 g) represented by Formula B-2a.

Next, the compound B-2a (3.6 g), paraoctyloxybenzoic acid (1.0 g), 1-ethyl-3-(3-dimethylaminopropyl)carbodiimide hydrochloride (1.0 g), and 4-N,N-dimethylaminopyridine (0.4 g) were dissolved in N,N-dimethylacetamide (DMAc) (30 mL), and the mixture was stirred at 50° C. for 8 hours. After stirring, methanol (50 mL) was added thereto, the obtained solid was collected by suction filtration, and silica gel column purification was performed to obtain a compound B-2b (1.1 g) represented by Formula B-2b.

Next, the compound B-2b (1.0 g), the compound B-1d (0.4 g), potassium carbonate (0.4 g), and potassium iodide (0.1 g) were dissolved in N,N-dimethylacetamide (DMAc) (10 mL), and the mixture was stirred at 85° C. for 8 hours. After stirring, hydrochloric acid (0.4 g), water (4 mL), and methanol (10 mL) were added thereto, and the obtained solid was collected by suction filtration to obtain a dichroic substance B-2 (1.1 g).

### [Synthesis of Dichroic Substance B-3]

The dichroic substance B-3 represented by Formula B-3 was synthesized according to the following scheme.

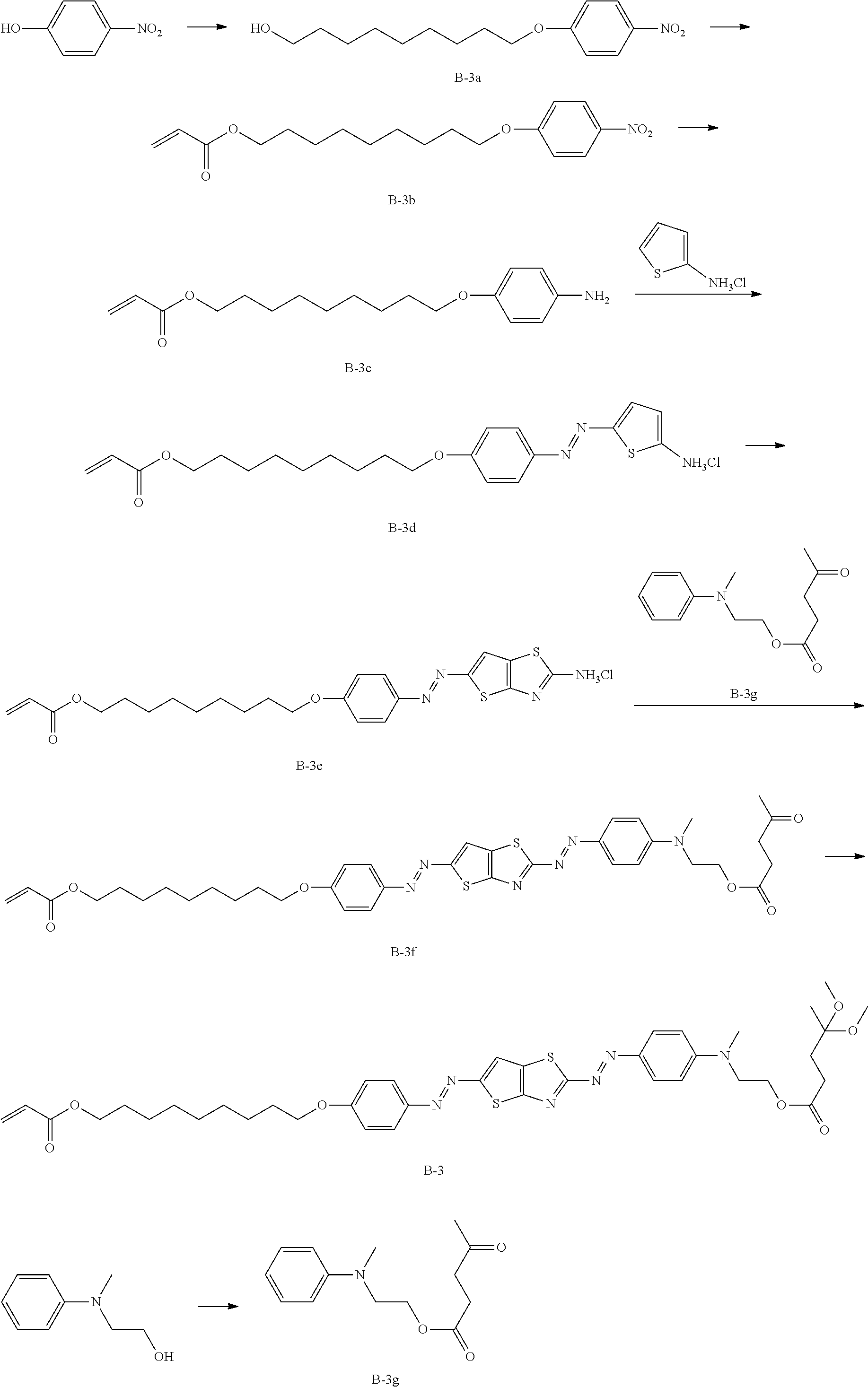

Specifically, 4-nitrophenol (27.8 g), 11-bromoundecanol (44.6 g), and potassium carbonate (30.4 g) were dissolved in N,N-dimethylacetamide (DMAc) (150 mL (milliliter)), and the mixture was stirred at an external device of 105° C. for 2 hours. The temperature was lowered to room temperature, and the mixture was separated and washed with an aqueous solution of ethyl acetate and 100 ammonium chloride. The organic layer was dried with magnesium sulfate, and then concentrated to obtain a white solid compound B-3a represented by Formula B-3a.

Next, DMAc (150 mL) was added to the white solid compound B-3a, and the mixture was stirred under ice bath. Acrylic acid chloride (18.1 g) was added dropwise thereto while maintaining the temperature of the reaction system at 15° C. or lower, and the mixture was stirred at room temperature for 1 hour after completion of the dropwise addition. Thereafter, ethyl acetate and a 10% ammonium chloride aqueous solution were added thereto, and the mixture was washed with a separating funnel. After drying with magnesium sulfate, the mixture was concentrated to obtain a yellow solid B-3b represented by Formula B-3b.

Separately, Fe powder (89.4 g, 1.6 mol), ammonium chloride (8.9 g, 166 mmol), 2-propanol (210 mL), and pure water (88 mL) were mixed and refluxed at an external device of 105° C. The yellow solid B-3b heated and dissolved in 2-propanol (88 mL) was added dropwise to the refluxed system. After completion of the dropwise addition, the reaction was carried out under reflux for 30 minutes. After cooling to room temperature, the iron powder was removed by celite filtration, and the filtrate was washed with ethyl acetate and water. The organic layer was washed with water three times.

The organic layer was dried over sodium sulfate and then concentrated. The column was purified to obtain 8.0 g of a compound B-3c represented by Formula B-3c. Separately, 2-aminothiophene was synthesized from 2-nitrothiophene according to the method described in the literature (Journal of Medicinal Chemistry, 2005, Vol. 48, p. 5794).

The compound B-3c (5.5 g) obtained above was added to a mixed solution of hydrochloric acid (15 mL), pure water (30 mL), and tetrahydrofuran (THF) (30 mL), and the mixture was cooled to have an internal temperature of 5° C. or lower, and sodium nitrite (1.4 g) was dissolved in pure water (9 mL) and added dropwise thereto. A diazonium solution was prepared by stirring at an internal temperature of 5° C. or lower for 1 hour.

Next, 2-aminothiophene hydrochloride (2.4 g) was dissolved in pure water (12 mL) and hydrochloric acid (6 mL), and the diazonium solution prepared above was added dropwise thereto at an internal temperature of 0° C. The reaction solution was raised to room temperature and stirred for 2 hours. The precipitated solid was filtered and dried to obtain 6.1 g of a red-orange solid B-3d represented by Formula B-3d.

The red-orange solid B-3d (5.6 g) obtained above was suspended and dissolved in acetic acid (100 mL), and sodium thiocyanate (1.5 g) was added thereto at room temperature. 2.0 g, 24.8 mmol of bromine was added dropwise thereto while the solution was water-cooled and the internal temperature was maintained at 20° C. or lower. After stirring at room temperature for 2 hours, pure water (100 mL) was added thereto, and the obtained solid was filtered and dried to obtain 5.5 g of a black solid B-3e represented by Formula B-3e.

Levulinic acid (10 g), 2-(N-methylanilino)ethanol (8.0 g), 1-ethyl-3-(3-dimethylaminopropyl)carbodiimide hydrochloride (6.0 g), and 4-N,N-dimethylaminopyridine (1.0 g) were dissolved in N,N-dimethylacetamide (DMAc) (30 mL), and the mixture was stirred at 50° C. for 2 hours. Methanol (10 mL) was added to stop the reaction, ethyl acetate (50 mL) and water (50 mL) were added thereto, and the mixture was subjected to a separation operation. The obtained organic layer was dried with magnesium sulfate, filtered, and the filtrate was concentrated to obtain a compound B-3g (15 g) represented by Formula B-3g.

The black solid B-3e (4.7 g) obtained above was added to hydrochloric acid (6 mL) and acetic acid (6 mL), and a sodium nitrite (0.72 g) aqueous solution (5 mL) was added dropwise thereto at 0° C. or lower under ice cooling, and after stirring for 1 hour, amide sulfate (0.52 mg) was added thereto to obtain a diazonium solution. The diazonium solution was added dropwise thereto while maintaining the 10 mL methanol solution of the compound B-3g (2.8 g) at 0° C. or lower. The mixture was raised to room temperature and stirred for 1 hour, and then pure water (30 mL) was added thereto. The obtained solid was filtered to obtain a black-purple solid compound B-3f represented by Formula B-3f.

Methanol (10 mL), tetrahydrofuran (50 mL), and (+)-camphorsulfonic acid (0.05 g) were added to the obtained compound B-3f (2.5 g), and trimethyl orthoformate (1.0 g) was added dropwise thereto over 10 minutes while maintaining the temperature in a water bath, and the mixture was stirred for 120 minutes. Saturated sodium hydrogen carbonate aqueous solution (5 mL) was added to stop the reaction, water (20 mL) and methanol (30 mL) were added thereto, and the obtained solid was collected by suction filtration to obtain a dichroic substance B-3 (2.4 g).

### [Synthesis of Dichroic Substance B-4]

The dichroic substance B-4 represented by Formula B-4 was synthesized according to the following scheme.

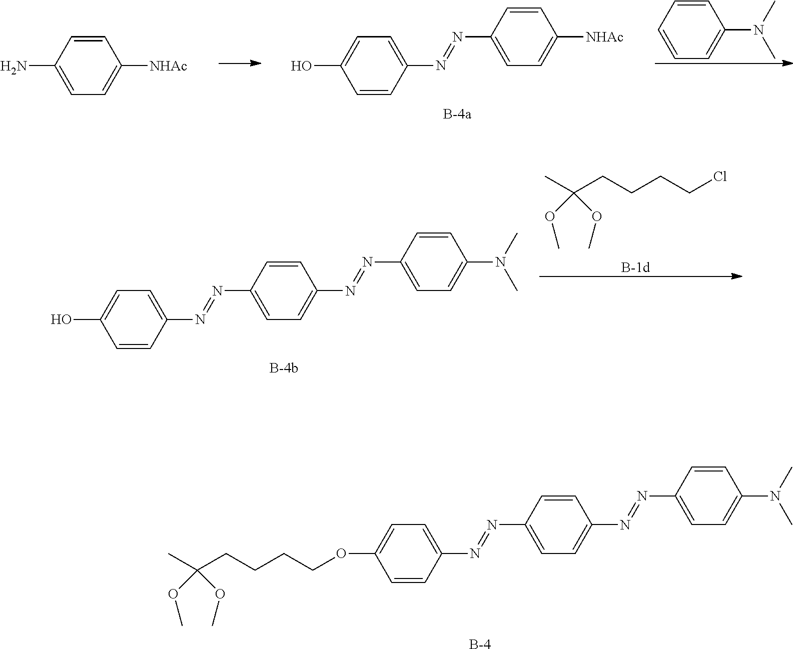

Specifically, p-acetanilide (10 g) was dissolved in water (300 mL) and 12 mol/L (liter) hydrochloric acid (17 mL), cooled in an ice bath, and sodium nitrite (3.3 g) was added thereto and stirred for 30 minutes. Furthermore, after adding amide sulfate (0.5 g), a solution obtained by mixing phenol (4.0 g), 48% potassium hydroxide aqueous solution (4.0 g), and water (24 mL) was added thereto and the mixture was stirred at room temperature for 1 hour. After stirring, the mixture was neutralized with hydrochloric acid, and the obtained solid was collected by suction filtration to obtain a compound B-4a (12 g) represented by Formula B-4a.

Next, the compound B-4a (40 g) was suspended in methanol (700 mL), water (240 mL), and hydrochloric acid (46 g), heated at 85° C. for 8 hours, cooled to room temperature, and sodium nitrite (11.9 g) was added thereto and stirred for 30 minutes. Furthermore, after adding amide sulfate (1.0 g), a solution obtained by mixing N,N-dimethylaniline (70 g), acetic acid (4.7 g), and methanol (320 mL) was added thereto and the mixture was stirred at room temperature for 1 hour. The obtained solid was collected by suction filtration to obtain a compound B-4b (48 g) represented by Formula B-4b.

Next, the compound B-4b (5.0 g), the compound B-1d (3.0 g), potassium carbonate (2.0 g), and potassium iodide (0.4 g) were dissolved in N,N-dimethylacetamide (DMAc) (20 mL), and the mixture was stirred at 85° C. for 8 hours. After stirring, hydrochloric acid (1.0 g), water (9 mL), and methanol (20 mL) were added thereto, and the obtained solid was collected by suction filtration to obtain a dichroic substance B-4 (5.6 g).

### [Synthesis of Dichroic Substance B-5]

The dichroic substance B-5 represented by Formula B-5 was synthesized according to the following scheme.

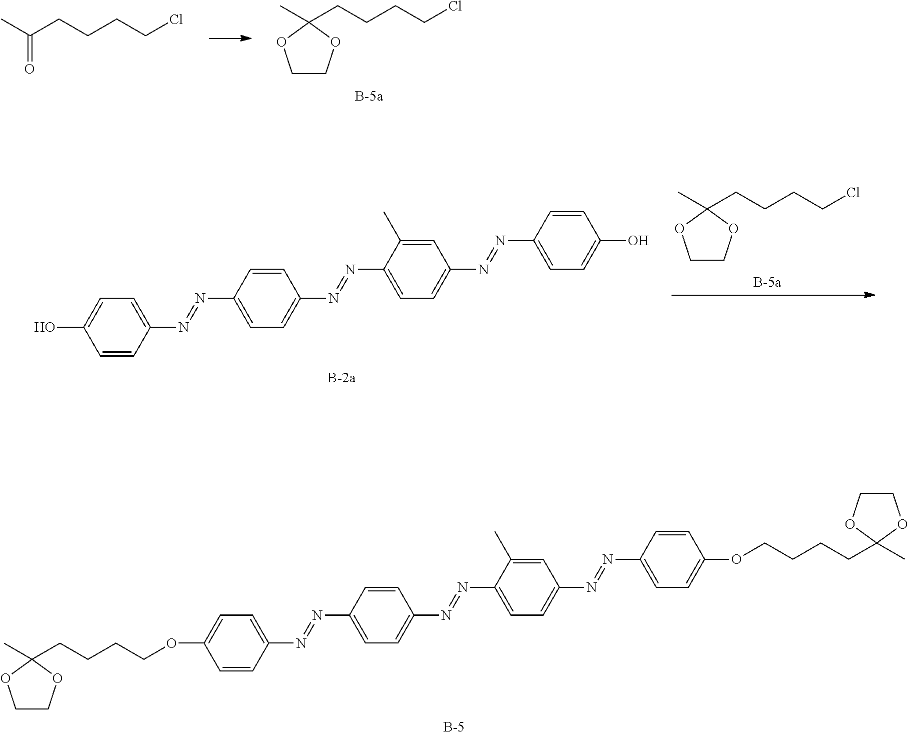

Specifically, first, ethylene glycol (100 mL) and (+)-camphorsulfonic acid (0.1 g) were added to 6-chloro-2-hexanone (25 g), and trimethyl orthoformate (20 g) was added dropwise thereto over 10 minutes while maintaining the temperature in a water bath, and the mixture was stirred for 30 minutes. Saturated sodium hydrogen carbonate aqueous solution (10 mL) was added to stop the reaction, hexane (200 mL) and water (200 mL) were added thereto, and the mixture was subjected to a separation operation. The obtained organic layer was dried with magnesium sulfate, filtered, and the filtrate was concentrated to obtain a compound B-5a (28 g) represented by Formula B-5a.

Next, the compound B-2a (3.6 g), the compound B-5a (2.0 g), potassium carbonate (1.0 g), and potassium iodide (0.3 g) were dissolved in N,N-dimethylacetamide (DMAc) (30 mL), and the mixture was stirred at 85° C. for 8 hours. After stirring, hydrochloric acid (1.0 g), water (8 mL), and methanol (30 mL) were added thereto, and the obtained solid was collected by suction filtration to obtain a dichroic substance B-5 (4.2 g).

### [Synthesis of Dichroic Substances B-6 to B-14]

The dichroic substances B-6 to 14 represented by Formulae B-6 to B-14 were synthesized by the same method as the dichroic substances B-1 to B-5, except for the side chain structure.

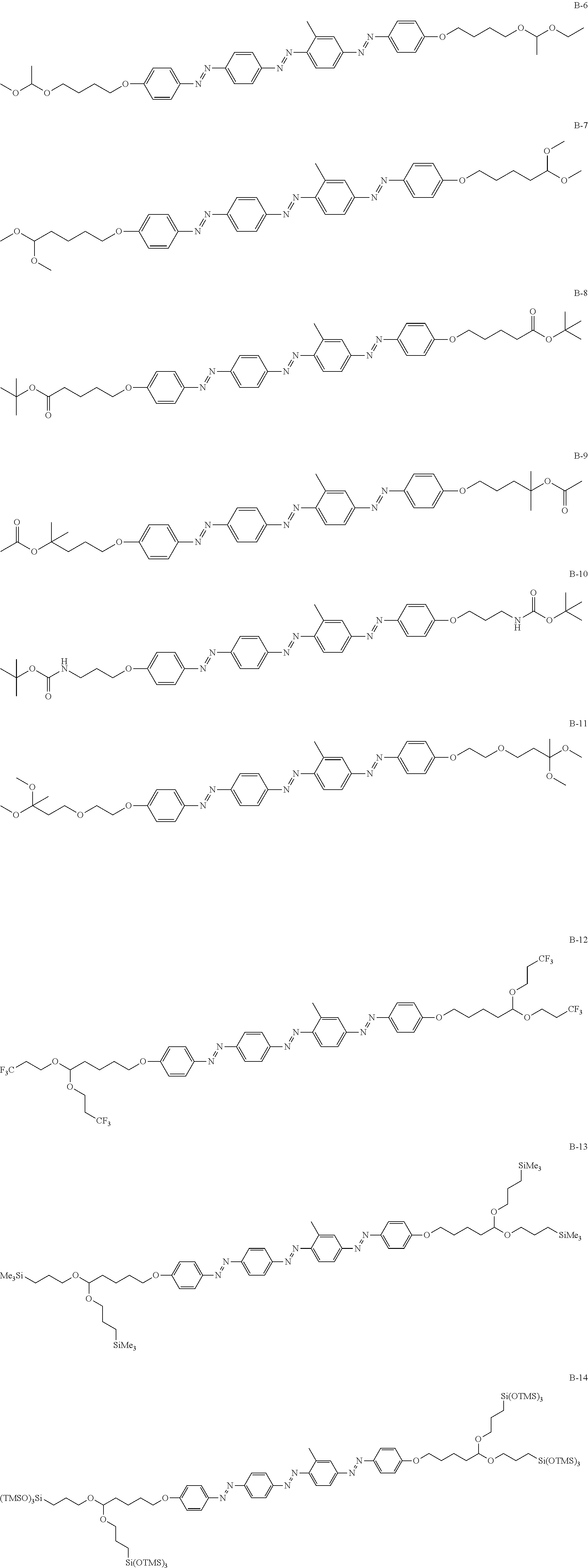

### [Synthesis of Dichroic Substances HB-1 to HB-3]

The dichroic substances HB-1 to HB-3 represented by Formulae HB-1 to HB-3 were synthesized by the same method as the dichroic substances B-1 to B-5, except for the side chain structure.

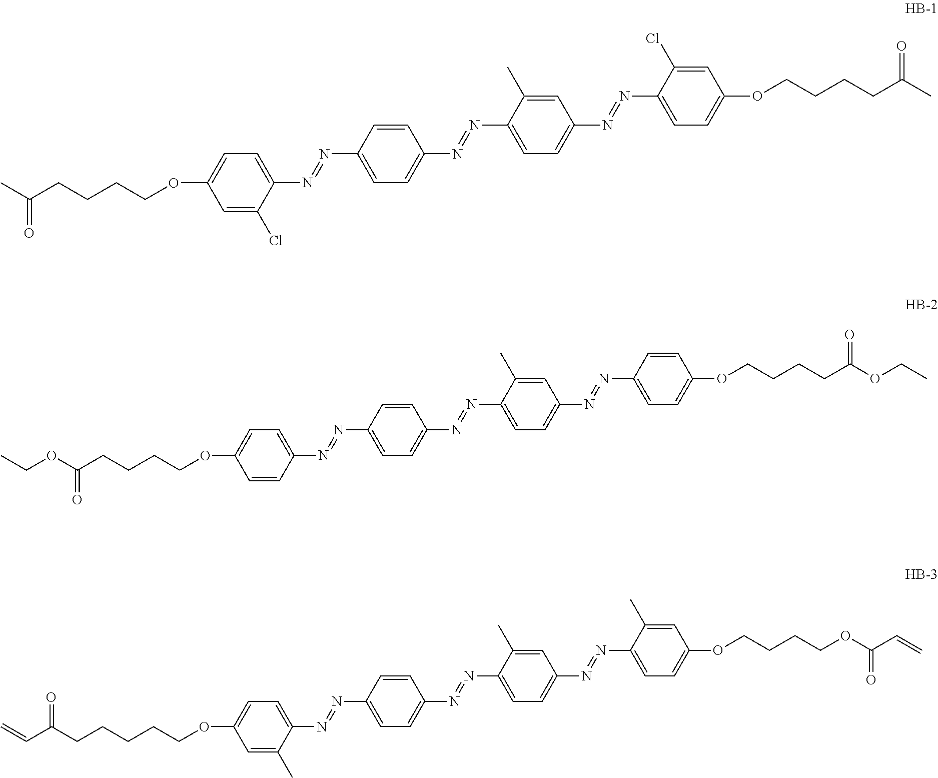

### Example 1

An optical laminate of Example 1 was produced as follows.

### [Production of Cellulose Acylate Film 1]

A cellulose acylate film 1 was prepared in the following manner.

### <Production of Core Layer Cellulose Acylate Dope>

The following composition was put into a mixing tank and stirred to dissolve each component, thereby preparing a cellulose acetate solution used as a core layer cellulose acylate dope.

Core layer cellulose acylate dope

| | |
|---|---|
| Cellulose acetate having acetyl substitution | 100 parts by mass |
| degree of 2.88 mass | |
| Polyester compound B described in Examples of | 12 parts by mass |
| JP2015-227955A | |
| Compound F shown below | 2 parts by mass |
| Methylene chloride (first solvent) | 430 parts by mass |
| Methanol (second solvent) | 64 parts by mass |

Compound F
Embedded image

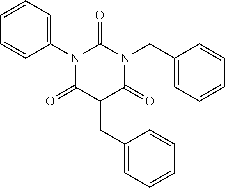 [SMILES: O=C1C(Cc2ccccc2)C(=O)N(c2ccccc2)C(=O)N1Cc1ccccc1]

### <Production of Outer Layer Cellulose Acylate Dope>

10 parts by mass of the following matting agent solution was added to 90 parts by mass of the above-described core layer cellulose acylate dope to prepare a cellulose acetate solution used as an outer layer cellulose acylate dope.

Matting agent solution

| | | |
|---|---|---|
| Silica particles with average particle size of 20 nm | 2 | parts by mass |
| (AEROSIL R972, manufactured by Nippon | | |
| Aerosil Co., Ltd.) | | |
| Methylene chloride (first solvent) | 76 | parts by mass |
| Methanol (second solvent) | 11 | parts by mass |
| Core layer cellulose acylate dope described above | 1 | part by mass |

### <Production of Cellulose Acylate Film 1>

The core layer cellulose acylate dope and the outer layer cellulose acylate dope were filtered through filter paper having an average pore size of 34 m and a sintered metal filter having an average pore size of 10 m, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were fixed by tenter clips, and the film was dried while being stretched at a stretching ratio of 1.1 times in the lateral direction.

Thereafter, the film was further dried by being transported between the rolls of the heat treatment device to prepare an optical film having a thickness of 40 m, and the optical film was used as a cellulose acylate film 1. The in-plane retardation of the obtained cellulose acylate film 1 was 0 nm.

[Production of optical laminate]

As described below, an optical laminate including the cellulose acylate film 1, the photo-alignment layer PA1, the light absorption anisotropic film P1, and the oxygen-shielding layer B1 adjacent to each other in this order was prepared.

<Preparation of TAC Film Provided with Photo-Alignment Layer>

A coating liquid PA1 for forming an alignment layer having the following composition was continuously applied onto the cellulose acylate film 1 with a wire bar. The support on which a coating film was formed was dried with hot air at 140° C. for 120 seconds, and the coating film was irradiated with polarized ultraviolet rays (10 mJ/cm², using an ultra-high pressure mercury lamp) to form a photo-alignment layer PA1, thereby obtaining a TAC film provided with a photo-alignment layer.

Coating liquid PA1 for forming alignment layer

| | |
|---|---|
| Polymer A1 shown below | 100.00 parts by mass |
| Acid generator SAN-AID SI-B3A | 12.00 parts by mass |
| DIPEA (N,N-diisopropylethylamine) | 0.6 parts by mass |
| Methyl ethyl ketone | 665.0 parts by mass |
| Butyl acetate | 166.00 parts by mass |

Polymer A1
A1 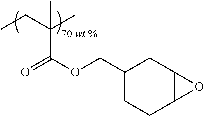 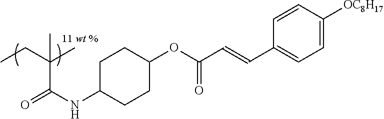 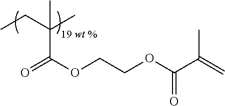
SAN-AID SI-B3A 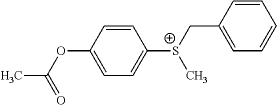 [SMILES: CC(=O)Oc1ccc([S+](C)Cc2ccccc2)cc1] 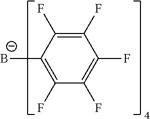
DIPEA

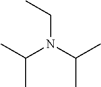

### <Formation of Light Absorption Anisotropic Film P1>

The following composition of a liquid crystal composition P1 was continuously applied onto the photo-alignment layer PA1 of the obtained TAC film with a photo-alignment layer with a wire bar to form a coating layer P1 (coating film forming step).

Next, the coating layer P1 was heated at 140° C. for 30 seconds, and the coating layer P1 was cooled to room temperature (23° C.) (cleavage step).

Next, the coating layer P1 was heated at 80° C. for 60 seconds and cooled to room temperature again (alignment step).

Thereafter, the coating layer P1 was irradiated with a light emitting diode (LED) lamp (central wavelength: 365 nm) for 2 seconds under an irradiation condition of an illuminance of 200 mW/cm², thereby forming a light absorption anisotropic film P1 on the photo-alignment layer PA1 (curing step). A thickness of the light absorption anisotropic film P1 was 2.0 μm.

Liquid crystal composition P1

| | |
|---|---|
| Polymerizable boronic acid compound B1 shown below | 0.150 parts by mass |
| Polymer liquid crystal compound L1 shown below | 2.680 parts by mass |
| Low-molecular-weight liquid crystal compound LM1 shown below | 1.201 parts by mass |
| Dichroic substance Y1 shown below | 1.081 parts by mass |
| Dichroic substance M1 shown below | 0.278 parts by mass |
| Dichroic substance C1 shown below | 1.142 parts by mass |
| Surfactant F1 shown below | 0.060 parts by mass |
| Acid generator SAN-AID SI-B3A | 0.054 parts by mass |
| Polymerization initiator I1 (IRGACURE, OXE-02, manufactured by BASF SE) | 0.054 parts by mass |
| Tetrahydrofuran | 46.000 parts by mass |
| Cyclopentanone | 47.000 parts by mass |

Polymerizable boronic acid compound B1
B1 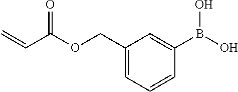
Polymer liquid crystal compound L1
L1 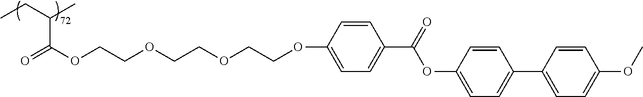 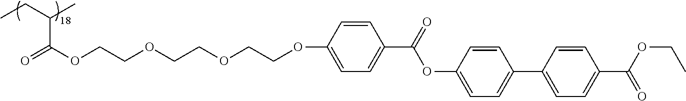 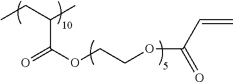
Low-molecular-weight liquid crystal compound LM1
LM1 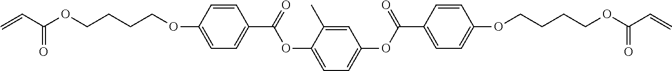 [SMILES: C=CC(=O)OCCCCOc1ccc(C(=O)Oc2ccc(OC(=O)c3ccc(OCCCCOC(=O)C=C)cc3)c(C)c2)cc1]
Dichroic substance Y1 (dichroic substance B-1) 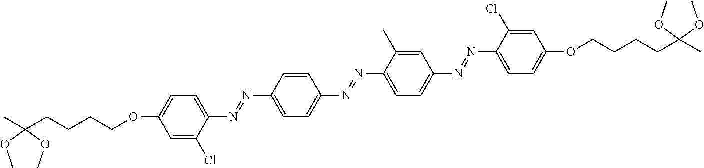 [SMILES: COC(C)(CCCCOc1ccc(/N=N/c2ccc(/N=N/c3ccc(/N=N/c4ccc(OCCCCC(C)(OC)OC)cc4Cl)cc3C)cc2)c(Cl)c1)OC]
Dichroic substance M1
M1 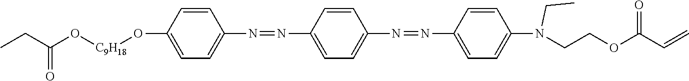
Dichroic substance C1
C1 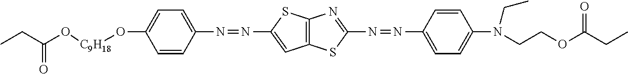
Surfactant F1

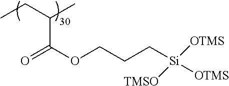

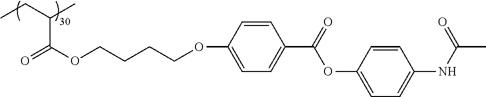

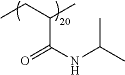

### <Formation of Oxygen Blocking Layer B1>

The following composition of an oxygen blocking layer forming composition B1 was continuously applied onto the formed light absorption anisotropic film P1 with a wire bar. Thereafter, the layer was dried with hot air at 100° C. for 2 minutes, thereby forming a polyvinyl alcohol (PVA) alignment layer (oxygen-shielding layer B1) having a thickness of 1.1 μm on the light absorption anisotropic film P1.

Composition B1 for forming oxygen shielding layer

| | |
|---|---|
| Modified polyvinyl alcohol shown below | 3.80 parts by mass |
| Initiator (IRGACURE 2959) | 0.20 parts by mass |
| Water | 70 parts by mass |
| Methanol | 30 parts by mass |

Modified polyvinyl alcohol

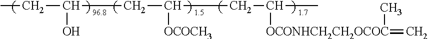

In this manner, the laminate A of Example 1, provided with the cellulose acylate film 1, the photo-alignment layer PA1, the light absorption anisotropic layer P1, and the oxygen-shielding layer B1 adjacent to each other in this order was obtained.

### Examples 2 to 14 and Comparative Examples 1 to 3

An optical laminate was produced by the same method as in Example 1, except that the dichroic substance Y1 (dichroic substance B-1) was replaced with the dichroic substance shown in Table 1.

### [Evaluation]

The following evaluations were performed using each of the produced optical laminates.

As a result of evaluating the alignment degree of the light absorption anisotropic film included in the laminate of each of Examples, in all of the light absorption anisotropic films included in the laminates of Examples, the polymer liquid crystal compound and the dichroic substance were horizontally aligned.

[Alignment degree]

Each optical laminate of the examples and the comparative examples was set on a sample table in a state where a linear polarizer was inserted on a light source side of an optical microscope (product name, “ECLIPSE E600 POL”, manufactured by Nikon Corporation), the absorbance of the light absorption anisotropic film in a wavelength range of 380 nm to 780 nm was measured at a pitch of 1 nm using a multi-channel spectroscope (product name, “QE65000”, manufactured by Ocean Optics, Inc.), and the alignment degree in a wavelength range of 400 nm to 700 nm was calculated according to the following equation. Based on the obtained alignment degree, the alignment degree was evaluated according to the following evaluation standards.

$$Degree of alignment : S = ( ( Az 0 / Ay 0 ) - 1 ) / ( ( Az 0 / Ay 0 ) + 2 )$$

In the equation described above, “Az0” represents the absorbance of the light absorption anisotropic film with respect to the polarized light in the absorption axis direction, and “Ay0” represents the absorbance of the light absorption anisotropic film with respect to the polarized light in the transmittance axis direction.
AA: The alignment degree was 0.95 or more
A: The alignment degree was 0.93 or greater and less than 0.95
B: The alignment degree was 0.90 or greater and less than 0.83
C: The alignment degree was less than 0.90

### [Solubility]

The liquid crystal compositions used in Examples 1 to 14 and Comparative Examples 1 to 3 were pressurized filtered (manufactured by Merck Millipore Corporation, 0.45 m filter), and the solubilities of the dichroic substances B-1 to B-14 and HB-1 to HB-3 were calculated from HPLC (system: manufactured by Shimadzu Corporation, column: manufactured by Tosoh Corporation, TSKgel ODS-100Z 4.6 mmID×15 cm 5 μm) measurement of the filtrate and the coating liquid.
Solubility=dichroic substance concentration in filtrate/dichroic substance concentration in composition

In the calculation of the solubility, a calibration curve created by preparing a dichroic substance solution at a concentration of 10 mg/10 mL, 1.0 mg/10 mL, 0.10 mg/10 mL, and 0.010 mg/10 mL and measuring each of the solutions by HPLC was used. The results were evaluated according to the following standards.

### <Evaluation Standard>

A: Solubility was 0.95 or more
B: Solubility was 0.50 or more and less than 0.95
C: Solubility was less than 0.50

TABLE 1

| | dichroic | | |
|---|---|---|---|
| | substance | alignment | |
| | type | degree | solubility |
| Example1 | B-1 | AA | A |
| Example2 | B-2 | A | A |
| Example3 | B-3 | A | A |
| Example4 | B-4 | A | A |
| Example5 | B-5 | A | B |
| Example6 | B-6 | A | A |
| Example7 | B-7 | A | A |
| Example8 | B-8 | A | A |
| Example9 | B-9 | A | A |
| Example10 | B-10 | B | A |
| Example11 | B-11 | A | A |
| Example12 | B-12 | A | A |
| Example13 | B-13 | A | A |
| Example14 | B-14 | B | A |
| Comparative | HB-1 | AA | C |
| Example1 | | | |
| Comparative | HB-2 | AA | C |
| Example2 | | | |
| Comparative | HB-3 | C | A |
| Example3 | | | |

From the results shown in Table 1, it was found that in a case where the dichroic substances HB-1 to HB-3 that did not correspond to the dichroic substance represented by Formula (1) was used, the solubility of the liquid crystal composition was poor in a case where the alignment degree of the light absorption anisotropic film was high, and the solubility of the liquid crystal composition was improved in a case where the alignment degree of the light absorption anisotropic film was low (Comparative Examples 1 to 3).

On the other hand, it was found that in a case where the dichroic substance represented by Formula (1) was used, the solubility of the liquid crystal composition was excellent, and the alignment degree of the light absorption anisotropic film was also high (Examples 1 to 14).

In particular, from the comparison of Examples 1 to 4, it was found that in a case where n in Formula (1) was an integer of two or more, the alignment degree of the light absorption anisotropic film was further increased.

In addition, from the comparison of Example 10 with other Examples, it was found that in a case where X in Formula (1) was the acid-cleavable group represented by any of Formulae (A1) to (A5), the alignment degree of the produced light absorption anisotropic film was further increased.

In addition, from the comparison of Example 5 with other Examples, it was found that in a case where two R^{A2}'s in Formula (A2) each independently represented a linear or branched monovalent aliphatic hydrocarbon group, the solubility of the liquid crystal composition was further improved.

In addition, from the comparison of Example 14 with other Examples, it was found that in a case where the molecular weight of R^{A2} in Formula (A2) was 300 or less, the alignment degree of the light absorption anisotropic film was further increased.

### Example 15

An optical laminate of Example 15 was produced as follows.

In a case where the transmittance central axis angle θ of the laminate produced in Example 15 was measured by the above-described method, the angle θ was 0°.

### (Production of Optically Anisotropic Film 2)

The following liquid crystal composition P2 was continuously applied onto the alignment film PA1 obtained by the same process as in Example 1 with a wire bar, and the coating film was heated at 120° C. for 60 seconds and cooled to room temperature (23° C.).

Next, the coating layer was heated at 85° C. for 60 seconds, and then cooled to room temperature again.

Thereafter, the coating layer was irradiated with an LED lamp (central wavelength of 365 nm) for 2 seconds under an irradiation condition of an illuminance of 200 mW/cm², thereby producing an optically anisotropic film 2 on the alignment film PAL. A film thickness of the optically anisotropic film 2 was 3.5 μm.

Liquid crystal composition P2

| | |
|---|---|
| Polymer liquid crystal compound L2 shown below | 6.069 parts by mass |
| Low-molecular-weight liquid crystal compound LM2 shown below | 3.843 parts by mass |
| Oxidative cleaved dichroic substance Y1 shown above | 1.305 parts by mass |
| Dichroic material M1 shown above | 0.262 parts by mass |
| Dichroic material C1 shown above | 1.829 parts by mass |
| Acid generator SAN-AID SI-B3A shown above | 0.054 parts by mass |
| Interface improver B2 shown below | 0.004 parts by mass |
| Alignment agent B3 shown below | 0.224 parts by mass |
| Alignment agent B4 shown below | 0.224 parts by mass |
| Polymerization initiator (IRGACURE OXE-02, manufactured by BASF SE) | 0.187 parts by mass |
| Cyclopentanone | 77.400 parts by mass |
| Benzyl alcohol | 8.600 parts by mass |

Polymer liquid crystal compound L2 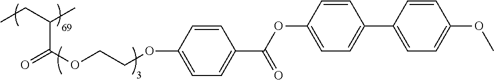 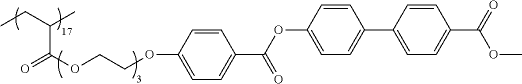 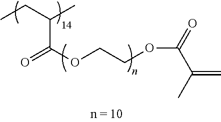
Low-molecular-weight liquid crystal compound LM2 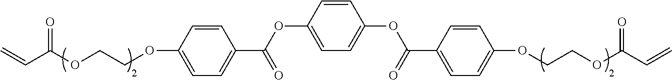
Interface improver B2 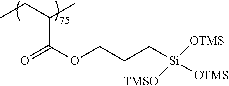 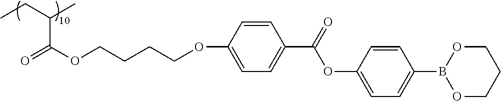 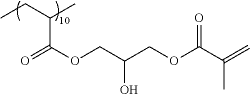 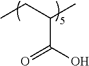
Alignment agent B3 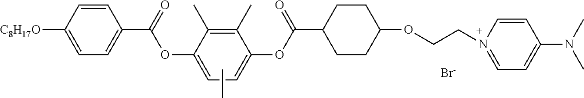
Alignment agent B4

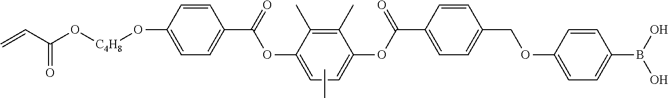

A polyvinyl alcohol (PVA) alignment layer (oxygen blocking layer B1) was formed on the obtained optically anisotropic film 2 in the same manner as in Example 1.

In this way, an optical laminate including the cellulose acylate film 1, the photo-alignment layer PA1, the light absorption anisotropic film P2, and the oxygen blocking layer B1 in this order adjacent to each other was produced.

In a case where the solubility of the liquid crystal composition P2 of the optical laminate produced in Example 15 was evaluated by the same method as in Example 1, the evaluation was A.

In addition, the alignment degree of the light absorption anisotropic film in the optical laminate produced in Example 15 was calculated by the following method, and the evaluation was AA according to the following standard.

In the measurement, the Mueller matrix at a wavelength of 400 nm to 700 nm at each polar angle was measured while the polar angle which was the angle with respect to the normal direction of the light absorption anisotropic film was changed from −70° to 70° at intervals of 1° using AxoScan OPMF-1 (manufactured by Opto Science, Inc.), and the minimum transmittance (Tmin) was derived.

Next, after removal of the influence of surface reflection, Tmin at a polar angle at which Tmin was highest was defined as Tm(0), and Tmin in a direction in which the polar angle was further increased by 40° from the polar angle at which Tmin was highest was defined as Tm(40).

The absorbance(A) was calculated by the following expression based on the obtained Tm(0) and Tm(40), and A(0) and A(40) were calculated.

$$A = - log ( Tm )$$

Here, Tm represents a transmittance and A represents an absorbance.

An alignment degree S_{P} at a wavelength of 400 nm to 700 nm, which was defined by the following expression, was calculated based on the calculated A(0) and A(40). Based on the obtained alignment degree, the alignment degree was evaluated according to the following evaluation standards.

$$S = ( 4.6 \times A ( 40 ) - A ( 0 ) ) / ( 4.6 \times A ( 40 ) + 2 \times A ( 0 ) )$$

AA: The alignment degree was 0.95 or more
A: The alignment degree was 0.93 or greater and less than 0.95
B: The alignment degree was 0.90 or greater and less than 0.83
C: The alignment degree was less than 0.90

What is claimed is:

1. A liquid crystal composition comprising:
a dichroic substance represented by Formula (1); and
a liquid crystal compound, 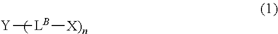
in Formula (1),
Y represents an n-valent coloring agent skeleton structure,
n represents an integer of one or more,
L^{B} represents a divalent aliphatic hydrocarbon group having one or more carbon atoms, and one or more —CH₂—'s constituting the aliphatic hydrocarbon group may be substituted with —CO—, —O—, —S—, —NH—, or —N(Q)-, Q represents a substituent, Provided that in a case where n represents an integer of two or more, a plurality of L^{b}'s may be the same as or different from each other, and
X represents an acid-cleavable group represented by any of Formulae (A1) to (A6), Provided that in a case where n represents an integer of two or more, a plurality of X's may be the same as or different from each other, 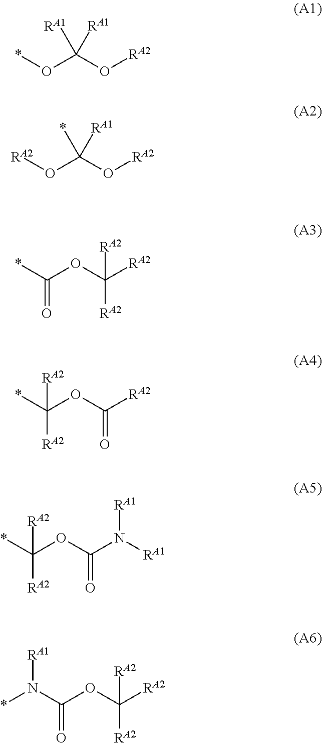
in Formulae (A1) to (A6),
represents a bonding position to L^{B},
R^{A1} represents a hydrogen atom or a monovalent hydrocarbon group, and a part of hydrogen atoms of the hydrocarbon group may be substituted with a halogen atom, and a part of carbon atoms may be substituted with silicon or oxygen, provided that two R^{A1}'s in Formulae (A1) and (A5) may be the same as or different from each other, and may be bonded to each other to form a ring,
R^{A2} represents a monovalent hydrocarbon group, and a part of hydrogen atoms of the hydrocarbon group may be substituted with a halogen atom, and a part of carbon atoms may be substituted with silicon or oxygen, and provided that a plurality of R^{A2}'s in Formulae (A2) to (A6) may be the same or different from each other, and may be bonded to each other to form a ring.

2. The liquid crystal composition according to claim 1,
wherein X in Formula (1) represents the acid-cleavable group represented by any of Formulae (A1) to (A5).

3. The liquid crystal composition according to claim 2,
wherein X in Formula (1) represents the acid-cleavable group represented by Formula (A2).

4. The liquid crystal composition according to claim 3,
wherein two R^{A2}'s in Formula (A2) each independently represent a linear or branched monovalent aliphatic hydrocarbon group.

5. The liquid crystal composition according to claim 4,
wherein a molecular weight of R^{A2} in Formula (A2) is 300 or less.

6. The liquid crystal composition according to claim 1,
wherein n in Formula (1) represents an integer of two or more.

7. The liquid crystal composition according to claim 1,
wherein the dichroic substance is represented by Formula (2), 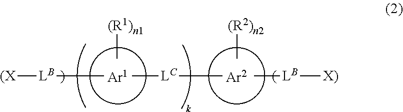
in Formula (2),
X and L^{B} are each defined as in the formula (1),
however, two X's may be the same or different from each other, and two L^{B}'s may be the same or different from each other,
n1 and n2 each independently represent an integer of 0 to 4,
k represents an integer of 1 to 4,
Ar¹ represents an (n1+2)-valent aromatic hydrocarbon group or an (n1+2)-valent heterocyclic group, however, in a case where k represents an integer of 2 to 4, a plurality of Ar¹'s may be the same or different from each other,
Ar² represents an (n2+2)-valent aromatic hydrocarbon group or an (n2+2)-valent heterocyclic group,
R¹ and R² each independently represent a substituent, however, in a case where n1 represents an integer of 2 to 4, a plurality of R¹'s may be the same or different from each other, and in a case where n2 represents an integer of 2 to 4, a plurality of R²'s may be the same or different from each other, and
L^{C} represents —N═N—, —N═CY—, —CY═CY—, —OCO—, —SCO—, or —NHCO—, and Y represents a substituent, provided that in a case where k represents an integer of 2 to 3, a plurality of L^{C}'s may be the same or different from each other.

8. The liquid crystal composition according to claim 1,
wherein a content of the dichroic substance is 4% to 80% by mass with respect to a total mass of solid contents of the liquid crystal composition.

9. An optically anisotropic film obtained by fixing an alignment state of the liquid crystal composition according to claim 1.

10. The optical absorption anisotropic film according to claim 9,
wherein the liquid crystal compound contained in the liquid crystal composition obtained by fixing in a horizontally alignment state.

11. The optical absorption anisotropic film according to claim 9,
wherein an angle θ between a transmittance central axis of the optical absorption anisotropic film and a normal direction of a surface of the optical absorption anisotropic film is 0° or more and 450 or less.

12. A method of producing an optical absorption anisotropic film obtained by fixing an alignment state of the liquid crystal composition according to claim 1, the method comprising:
a coating film forming step of applying the liquid crystal composition to form a coating film;
a cleavage step of generating an acid in the coating film by light irradiation or heating after the coating film forming step to cleave an acid-cleavable group of the dichroic substance represented by Formula (1);
an alignment step of aligning the dichroic substance having the cleaved acid-cleavable group after the cleavage step; and
a curing step of fixing an alignment state of the dichroic substance after the alignment step to obtain the optical absorption anisotropic film.

13. An optical laminate comprising:
the optical absorption anisotropic film according to claim 9.

14. An image display apparatus comprising:
the optical absorption anisotropic film according to claim 9.

15. The liquid crystal composition according to claim 2,
wherein n in Formula (1) represents an integer of two or more.

16. The liquid crystal composition according to claim 2,
wherein the dichroic substance is represented by Formula (2), 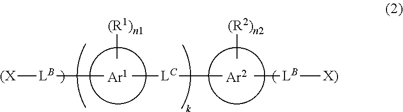
in Formula (2),
X and L^{B} are each defined as in the formula (1),
however, two X's may be the same or different from each other, and two L^{B}'s may be the same or different from each other,
n1 and n2 each independently represent an integer of 0 to 4,
k represents an integer of 1 to 4,
Ar¹ represents an (n1+2)-valent aromatic hydrocarbon group or an (n1+2)-valent heterocyclic group, however, in a case where k represents an integer of 2 to 4, a plurality of Ar²'s may be the same or different from each other,
Ar² represents an (n2+2)-valent aromatic hydrocarbon group or an (n2+2)-valent heterocyclic group,
R¹ and R² each independently represent a substituent, however, in a case where n1 represents an integer of 2 to 4, a plurality of R¹'s may be the same or different from each other, and in a case where n2 represents an integer of 2 to 4, a plurality of R²'s may be the same or different from each other, and
L^{C} represents —N═N—, —N═CY—, —CY═CY—, —OCO—, —SCO—, or —NHCO—, and Y represents a substituent, provided that in a case where k represents an integer of 2 to 3, a plurality of L^{C}'s may be the same or different from each other.

17. The liquid crystal composition according to claim 2,
wherein a content of the dichroic substance is 4% to 80% by mass with respect to a total mass of solid contents of the liquid crystal composition.

18. An optically anisotropic film obtained by fixing an alignment state of the liquid crystal composition according to claim 2.

19. The optical absorption anisotropic film according to claim 18,
wherein the liquid crystal compound contained in the liquid crystal composition obtained by fixing in a horizontally alignment state.

20. The optical absorption anisotropic film according to claim 18,
wherein an angle θ between a transmittance central axis of the optical absorption anisotropic film and a normal direction of a surface of the optical absorption anisotropic film is 0° or more and 450 or less.
